(19) United States
(12) Patent Application Publication
(10) Pub. No.: US 2026/0311200 A1
(43) Pub. Date: Oct. 8, 2026

(54) METHOD FOR CALCULATING GROWTH POTENTIAL INDEX OF PROMISING ARTIST IN TARGET CITY, METHOD FOR RECOMMENDING PROMISING ARTIST IN THE TARGET CITY USING THE SAME, AND SERVER FOR PERFORMING THE METHODS

(71) Applicant: LIGHTERS COMPANY CO.,LTD, Daejeon (KR)

(72) Inventors: Ha Mi KIM, Seoul (KR); Jin Seok LEE, Seoul (KR)

(21) Appl. No.: 19/641,357

(22) Filed: Apr. 7, 2026

(30) Foreign Application Priority Data
Apr. 7, 2025 (KR) 10-2025-0044711
Apr. 7, 2025 (KR) 10-2025-0044712
Apr. 7, 2025 (KR) 10-2025-0044713
Apr. 7, 2025 (KR) 10-2025-0044714
Apr. 7, 2025 (KR) 10-2025-0044715

(51) Int. Cl. G06Q 30/0201

(52) U.S. Cl. CPC G06Q 30/02017

(57) ABSTRACT

A method for calculating a growth potential index of a promising artist in a target city, a method for recommending a promising artist in the target city using the same, and a server for performing said methods are disclosed. The disclosed method for recommending a promising artist in a target city is performed in a processor-based device and comprises a step of calculating a growth potential index for each of a plurality of promising artists with respect to the target city, and a step of recommending one or more promising artists from among the plurality of promising artists based on the growth potential index for each of the plurality of promising artists.

### CROSS-REFERENCE TO RELATED APPLICATION

This application claims priority to and the benefit of (1) Korean Patent Application No. 2025-0044711, filed on Apr. 7, 2025, (2) Korean Patent Application No. 2025-0044712, filed on Apr. 7, 2025, (3) Korean Patent Application No. 2025-0044713, filed on Apr. 7, 2025, (4) Korean Patent Application No. 2025-0044714, filed on Apr. 7, 2025, and (5) Korean Patent Application No. 2025-0044715, filed on Apr. 7, 2025, the disclosure of which is incorporated herein by reference in its entirety.

### BACKGROUND

### 1. Field of the Invention

Embodiments of the present invention relate to a method for calculating a growth potential index of a promising artist in a target city, a method for recommending a promising artist in the target city using the same, and a server for performing said methods.

Embodiments of the present invention relate to a method for recommending a city for a promising artist and a server for performing the same.

Embodiments of the present invention relate to a method for calculating a popularity potential index of a promising artist in a target city and a server for performing the same.

### 2. Discussion of Related Art

An artist refers to an individual or a member within a group active in the music industry, and is defined to include performers such as singers and rappers, as well as composers and producers. Artists exert strong influence not only by simply creating and performing music, but also in cultural, social, and economic aspects.

Recently, along with the growth of the global music market, domestic artists are increasingly advancing into overseas markets. Accordingly, it is becoming increasingly important to evaluate the possibility of an artist's success in a specific city in advance and to establish a strategic entry plan based on such evaluation. In particular, when hosting public cultural events such as music concerts or festivals in a specific city, it is important to select appropriate artists by considering the cultural characteristics of that city and preferences toward artists.

However, conventionally, such judgments have mostly relied on the subjective experience or intuition of the person in charge, which has the limitation that quantitative factors such as market characteristics by city or the growth potential of fandoms are not sufficiently reflected. This subjective decision-making approach often leads to inadequate market responses or below-expected results after actual entry, which can consequently cause social and economic losses to not only the artist but also to agencies and the industry as a whole.

Furthermore, discovering promising artists who are not yet widely known to the public but have high growth potential in the future is an important challenge throughout the music industry; however, technologies capable of systematically analyzing or quantitatively judging this are lacking.

Therefore, there is a need for technology that can efficiently evaluate the growth potential of artists active in a specific city and recommend artists suitable for that city based on such evaluation.

### SUMMARY OF THE INVENTION

An object of the present invention is to provide a method and server for calculating a growth potential index of a promising artist—a measure indicating how much more popular a promising artist will grow in a specific city in the future—through the actual popularity of the promising artist in that specific city and an attribute comparison between popular artists and promising artists in that specific city.

Another object of the present invention is to provide a method and server for calculating a popularity potential index of a promising artist—a predicted popularity index indicating how much popularity a promising artist in a specific city can attain compared to popular artists in that specific city.

Another object of the present invention is to provide a method and server for recommending promising artists with a high probability of success in a specific city, based on the growth potential index for each promising artist in that specific city.

Another object of the present invention is to provide a method and server for recommending one or more cities suitable for a promising artist to conduct or promote promotional activities, from among a plurality of cities, based on the growth potential index for each promising artist with respect to each of the plurality of cities.

The objects of the present invention are not limited to the objects mentioned above, and other objects and advantages of the present invention not mentioned above may be understood from the following description and will be more clearly understood by the embodiments of the present invention. In addition, it will be readily understood that the objects and advantages of the present invention can be realized by the means and combinations thereof as set forth in the claims.

A method for recommending a promising artist in a target city according to an embodiment of the present invention is performed in a processor-based device and comprises: a step of calculating a growth potential index for each of a plurality of promising artists with respect to the target city; and a step of recommending one or more promising artists from among the plurality of promising artists based on the growth potential index for each of the plurality of promising artists. In this case, the growth potential index for each of the plurality of promising artists is calculated based on the actual popularity of each of the plurality of promising artists in the target city and the similarity between each of the plurality of promising artists and a popular artist in the target city.

In addition, a method for calculating a growth index of a promising artist in a target city according to an embodiment of the present invention is performed in a processor-based device and comprises: a step of calculating a first popularity index of the promising artist corresponding to the actual popularity of the promising artist with respect to the target city; a step of calculating a second popularity index of the promising artist corresponding to the similarity between a popular artist in the target city and the promising artist; and a step of calculating a growth potential index of the promising artist based on the first and second popularity indexes of the promising artist.

In addition, a server according to an embodiment of the present invention comprises a memory storing computer-readable instructions and a processor implemented to execute the instructions. In this case, the processor calculates a growth potential index for each of a plurality of promising artists with respect to the target city, and recommends one or more promising artists from among the plurality of promising artists based on the growth potential index for each of the plurality of promising artists, wherein the growth potential index for each of the plurality of promising artists is calculated based on the actual popularity of each of the plurality of promising artists in the target city and the similarity between each of the plurality of promising artists and a popular artist in the target city.

In addition, a server according to another embodiment of the present invention comprises a memory storing computer-readable instructions and a processor implemented to execute the instructions. In this case, the processor calculates a first popularity index of the promising artist corresponding to the actual popularity of the promising artist with respect to the target city, calculates a second popularity index of the promising artist corresponding to the similarity between a popular artist in the target city and the promising artist, and calculates a growth potential index of the first promising artist based on the first and second popularity indexes of the promising artist.

A method for recommending a city for a promising artist according to an embodiment of the present invention is performed in a processor-based device and comprises: a step of calculating a growth potential index for each of a plurality of cities with respect to the promising artist; and a step of recommending one or more cities from among the plurality of cities for the promising artist based on the growth potential index for each of the plurality of cities. In this case, the growth potential index for each of the plurality of cities is calculated based on the actual popularity of the promising artist in each of the plurality of cities and the similarity between the promising artist and a popular artist in each of the plurality of cities.

In addition, a server according to an embodiment of the present invention comprises a memory storing computer-readable instructions and a processor implemented to execute the instructions. In this case, the processor calculates a growth potential index for each of a plurality of cities with respect to the promising artist and recommends one or more cities from among the plurality of cities for the promising artist based on the growth potential index for each of the plurality of cities, wherein the growth potential index for each of the plurality of cities is calculated based on the actual popularity of the promising artist in each of the plurality of cities and the similarity between the promising artist and a popular artist in each of the plurality of cities.

A method for calculating a popularity potential index of a target city for a promising artist according to an embodiment of the present invention is performed in a processor-based device and comprises: a step of generating input data comprising first artist attribute data for popular artists in the target city, second artist attribute data for the promising artist in the target city, city attribute data of the target city, and popularity index data for the popular artists in the target city; and a step of calculating a popularity potential index of the target city for the promising artist based on the input data.

In addition, a server for calculating a popularity potential index of a target city for a promising artist according to an embodiment of the present invention comprises a memory storing computer-readable instructions and a processor implemented to execute the instructions. In this case, the processor generates input data comprising first artist attribute data for popular artists in the target city, second artist attribute data for the promising artist in the target city, city attribute data of the target city, and popularity index data of the target city for the popular artists, and calculates a popularity potential index of the target city for the promising artist based on the input data.

According to the present invention, the growth potential index of a promising artist—a measure indicating how much more popular a promising artist will grow in a specific city in the future—can be efficiently calculated through the actual popularity of the promising artist in the specific city and an attribute comparison between popular artists and promising artists in that specific city.

In addition, according to the present invention, a popularity potential index corresponding to the likelihood of a promising artist succeeding in a specific city can be calculated by taking into account the attribute information of popular artists who have established recognition in that specific city and the unique city attributes of the specific city. Accordingly, a person in charge can systematically and accurately determine whether to enter a specific city based on the popularity potential index.

In addition, according to the present invention, promising artists with a high probability of success in a specific city can be recommended based on the growth potential index for each promising artist in that specific city. Through such artist recommendations, events held in a specific city can be conducted successfully.

In addition, according to the present invention, one or more cities suitable for a promising artist to conduct or promote promotional activities can be efficiently recommended from among a plurality of cities, based on the growth potential index for each promising artist with respect to each of the plurality of cities.

Furthermore, the effects of the present invention are not limited to the above-described effects and should be understood to include all effects that can be inferred from the configuration of the invention described in the detailed description or claims of the present invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a schematic configuration of a system according to an embodiment of the present invention.

FIG. 2 is a diagram showing a schematic configuration of a service server according to an embodiment of the present invention.

FIG. 3 is a diagram showing an overall flowchart of a method for recommending a promising artist in a target city according to an embodiment of the present invention.

FIG. 4 is a diagram showing a detailed flowchart of some of the steps in FIG. 3.

FIG. 5 is a diagram showing a detailed flowchart of some of the steps in FIG. 4.

FIG. 6 is a diagram showing a detailed flowchart of another step among the steps in FIG. 4.

FIG. 7 is a diagram showing a detailed flowchart of some of the steps in FIG. 6.

FIG. 8 is a diagram showing first artist attribute data of a popular artist according to an embodiment of the present invention.

FIG. 9 is a diagram showing a detailed flowchart of some other steps among the steps in FIG. 3.

FIG. 10 is a diagram showing an overall flowchart of a method for recommending a city for a promising artist according to an embodiment of the present invention.

FIG. 11 is a diagram showing a detailed flowchart of some of the steps in FIG. 10.

FIG. 12 is a diagram showing a detailed flowchart of some of the steps in FIG. 11.

FIG. 13 is a diagram showing a detailed flowchart of another step among the steps in FIG. 11.

FIG. 14 is a diagram showing a detailed flowchart of some of the steps in FIG. 13.

FIG. 15 is a diagram showing first artist attribute data of a popular artist according to an embodiment of the present invention.

FIG. 16 is a diagram showing a detailed flowchart of some other steps among the steps in FIG. 10.

FIG. 17 is a diagram showing an overall flowchart of a method for calculating a popularity potential index according to an embodiment of the present invention.

FIG. 18 is a diagram showing a detailed flowchart of some of the steps in FIG. 17.

FIG. 19 is a diagram illustrating the concept of calculating facial data from a single image according to an embodiment of the present invention.

FIG. 20 is a diagram showing first artist attribute data of a popular artist according to an embodiment of the present invention.

FIG. 21 is a diagram showing a detailed flowchart of some other steps among the steps in FIG. 17.

FIG. 22 is a diagram showing an overall flowchart of a method for calculating the popularity index of an artist in a target city according to an embodiment of the present invention.

### DETAILED DESCRIPTION OF EXEMPLARY EMBODIMENTS

As the present invention allows for various modifications and can have various embodiments, specific embodiments will be illustrated in the drawings and described in detail. However, this is not intended to limit the present invention to specific embodiments and should be understood to include all modifications, equivalents, and substitutes within the spirit and technical scope of the present invention. Similar reference numerals are used for similar components throughout the description of the drawings.

Terms such as “first” and “second” may be used to describe various components, but the components should not be limited by these terms. These terms are used only for the purpose of distinguishing one component from another. The term “and/or” includes a combination of a plurality of related listed items or any of a plurality of related listed items.

When a component is referred to as being “connected” or “coupled” to another component, it may be directly connected or coupled to the other component, but it should be understood that other components may exist in between. In contrast, when a component is referred to as being “directly connected” or “directly coupled” to another component, it should be understood that there are no other components in between.

The terminology used herein is used only to describe specific embodiments and is not intended to limit the present invention. Singular expressions include plural expressions unless the context clearly dictates otherwise. In this application, terms such as “comprises” or “has” are intended to designate the existence of features, numbers, steps, operations, components, parts, or combinations thereof described in the specification, and should not be understood to preclude in advance the possibility of the existence or addition of one or more other features, numbers, steps, operations, components, parts, or combinations thereof.

Unless otherwise defined, all terms used herein, including technical or scientific terms, have the same meanings as commonly understood by a person of ordinary skill in the technical field to which the present invention belongs. Terms defined in commonly used dictionaries should be interpreted as having meanings consistent with the contextual meaning in the relevant art, and should not be interpreted in an idealized or overly formal sense unless explicitly defined in this application.

Hereinafter, embodiments according to the present invention will be described in detail with reference to the accompanying drawings.

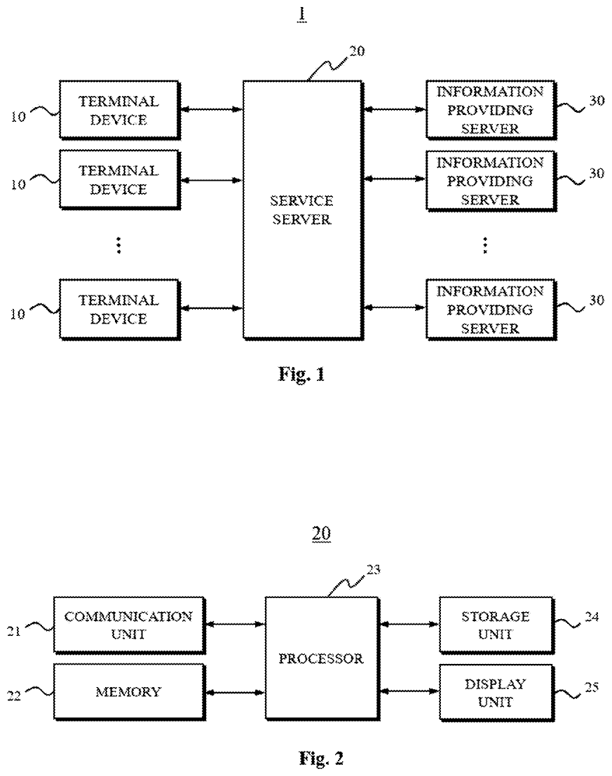

FIG. 1 is a diagram showing a schematic configuration of a system according to an embodiment of the present invention.

Referring to FIG. 1, a system 1 according to an embodiment of the present invention may include a plurality of terminal devices 10, a service server 20, and an information providing server 30.

Each of the plurality of terminal devices 10 may be a processor-based device owned by a user. In this case, the user corresponds to a fan of a specific artist.

Here, an artist may mean a solo artist or a member artist included in a group artist. For example, when the group artist is BTS, the artist may be V (Taehyung).

In one embodiment, the service server 20 may be a processor-based device that is communicatively connected to each of the plurality of terminal devices 10 and provides a fandom service to a plurality of users corresponding to fans.

Here, a fandom service may be defined as a platform or service that promotes fan participation and communication with artists. Through the fandom service, fans can strengthen their bond with artists. For example, the fandom service may be configured to include fan participation services such as popularity voting for artists and writing comments in artist communities, content provision services that provide various content such as music, videos, and interviews of artists, merchandise sales services that sell fan goods, albums, and concert tickets for artists, and event provision services that provide events such as fan meetings. Fan activities using such a fandom service may correspond to online fandom activities for a specific artist, and data related to the fandom service may be stored as log data in the service server 20.

In addition, the service server 20 may calculate a popularity index, growth potential index, etc. of an artist based on information obtained through the information providing server 30, and in particular, may recommend a promising artist in a specific city based on the calculated information.

Here, a promising artist of a specific city refers to an artist who is not yet widely known in that specific city.

Alternatively, the service server 20 may calculate a popularity index, growth potential index, etc. of an artist based on information obtained through the information providing server 30, and in particular, may recommend a city for a promising artist based on the calculated information.

In yet another embodiment, the service server 20 may be a processor-based device that calculates a popularity potential index of a promising artist for each of a plurality of cities. Accordingly, the popularity potential index of a promising artist in a specific city may correspond to a predicted popularity index indicating how popular the promising artist in the specific city will be at a future point in time.

According to an embodiment, the service server 20 may calculate the popularity potential index of a promising artist in a specific city based on information about popular artists who are already famous in that specific city and information about the specific city.

The information providing server 30 may be a processor-based device that provides various information about various artists and other information.

Meanwhile, although only one information providing server 30 is shown in FIG. 1, the present invention is not limited thereto, and two or more information providing servers 30 may be included in the recommendation system 1.

According to an embodiment, the information providing server 30 may include a plurality of streaming servers that provide music streaming services or video streaming services. The plurality of streaming servers may transmit streaming data related to statistics of streaming history of music streaming services and/or video streaming services to the service server 20.

Specifically, the plurality of streaming servers may include two or more first streaming servers that provide music streaming services. Here, the first streaming servers may correspond to music streaming platforms widely used in many countries. For example, the first streaming servers may be streaming servers corresponding to Spotify, Apple Music, Deezer, iTunes, Shazam, Amazon Music, etc.

Meanwhile, each of the two or more first streaming servers may generate and manage music charts. Here, the music charts may include at least one of a music chart for music tracks and a music chart for music albums. Music charts may be generated by city or by country.

In addition, the plurality of streaming servers may include one or more second streaming servers that provide video streaming services. Here, the second streaming servers may also correspond to video platforms widely used in many countries. For example, the second streaming server 30 may be a streaming server corresponding to YouTube, TikTok, etc.

In addition, according to an embodiment, the information providing server 30 may provide profile information of artists, artist images, information for each of a plurality of cities, etc.

The configuration of the service server 20 will now be described with reference to FIG. 2.

FIG. 2 is a diagram showing a schematic configuration of the service server 20 according to an embodiment of the present invention.

Referring to FIG. 2, the service server 20 may include a communication unit 21, a memory 22, a processor 23, a storage unit 24, and a display unit 25.

The communication unit 21 may communicate with the plurality of terminal devices 10 and the information providing server 30. For example, the communication unit 21 may be a short-range communication module and/or a long-range communication module. The short-range communication module may be a communication module according to Bluetooth, RFID (Radio Frequency Identification), IrDA (Infrared Data Association), UWB (Ultra-Wideband), ZigBee, or WiFi (Wireless Fidelity). The long-range communication module may be a communication module according to CDMA (Code Division Multiple Access), FDMA (Frequency Division Multiple Access), TDMA (Time Division Multiple Access), OFDMA (Orthogonal Frequency Division Multiple Access), or SC-FDMA (Single Carrier Frequency Division Multiple Access).

The memory 22 may be volatile and/or non-volatile memory and may store instructions or data related to at least one other component of the service server 20. In particular, the memory 22 may store instructions or data related to computer programs, applications, recording media, etc. executed in the service server 20.

The processor 23 may include one or more of a central processing unit, an application processor, or a communication processor. The processor 23 may perform operations or data processing related to control and/or communication of at least one other component of the service server 20. In particular, the processor 23 may execute instructions of computer programs/applications.

The storage unit 24 may store various data. In particular, the storage unit 24 may store the above-described log data.

The display unit 25 may be composed of a liquid crystal display (LCD), a light emitting diode display (LED), an organic light emitting diode display (OLED), etc., and is a device capable of displaying images or image frames. In particular, the display unit 25 may output an execution screen of a computer program or application executed by the processor 23.

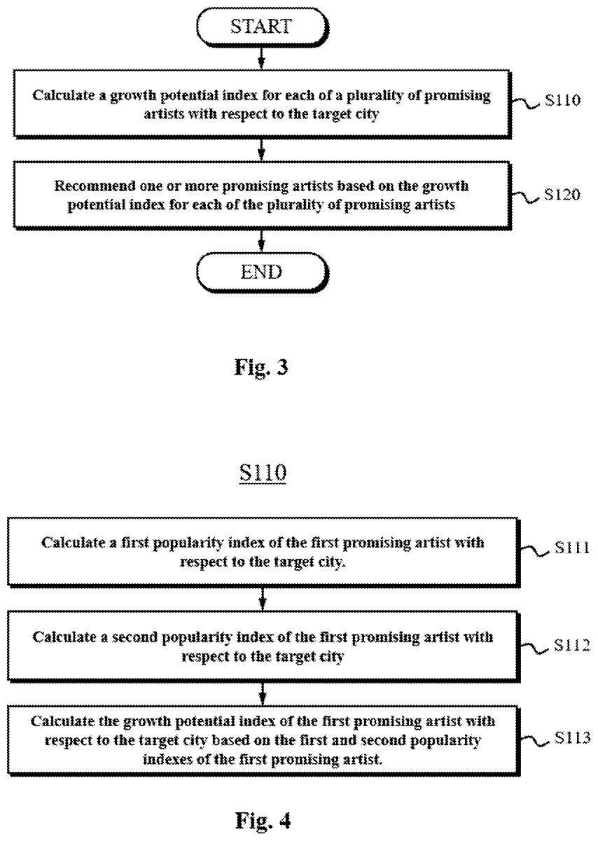

Hereinafter, a method for recommending a promising artist in a target city, which is performed by the processor 23 of the service server 20, will be described in detail with reference to FIG. 3 and the like.

FIG. 3 is a diagram showing an overall flowchart of a method for recommending a promising artist in a target city according to an embodiment of the present invention.

The steps of FIG. 3 will be described in detail below.

In step S110, the service server 20 may calculate a growth potential index for each of a plurality of promising artists with respect to the target city.

As described above, a promising artist may refer to an artist who is not yet widely known in the target city. The growth potential index of a promising artist may be defined as a measure indicating how much more popular the promising artist will grow in the target city in the future.

According to an embodiment, the service server 20 may calculate the growth potential index of a promising artist based on the actual popularity of each of the plurality of promising artists in the target city and an attribute comparison between the popular artists of the target city and each of the plurality of promising artists. Here, a popular artist of the target city refers to an artist who is already well-known in the target city, and the attribute comparison may correspond to the similarity between the popular artist and the promising artist.

Step S110 will be described in detail below.

FIG. 4 is a diagram showing a detailed flowchart of step S110 among the steps of FIG. 3.

Here, the steps shown in FIG. 4 represent steps for calculating the growth potential index of a first promising artist among a plurality of promising artists. These steps of FIG. 4 may be equally applied to other promising artists in the target city besides the first promising artist. Meanwhile, the steps shown in FIG. 4 may also constitute a separate method for calculating the growth potential index of a promising artist in the target city.

In step S111, the service server 20 may calculate a first popularity index of the first promising artist with respect to the target city.

Here, the first popularity index of the first promising artist may correspond to the actual popularity of the first promising artist with respect to the target city.

According to an embodiment, the first popularity index may be a total popularity index, which is the actual popularity index of the first promising artist up to a specific date. Here, the total popularity index may correspond to the cumulative popularity index, long-term popularity index, career popularity index, overall popularity index, etc. of the first promising artist. However, the present invention is not limited thereto, and the first popularity index may be a current popularity index, which is the actual popularity index of the first promising artist on a specific date itself. Here, the current popularity index may correspond to the short-term popularity index, recent popularity index, etc. of the first promising artist. Hereinafter, the first popularity index is assumed to be the total popularity index in describing this embodiment.

Meanwhile, the first popularity index of the popular artist may be stored in the storage unit 24 after step S111 has been performed in advance. For example, a popular artist may be an artist having a ratio of the first popularity index in the upper rank among a plurality of artists active or scheduled to be active in the target city.

Step S111 will now be described in more detail.

FIG. 5 is a diagram showing a detailed flowchart of step S111 among the steps of FIG. 4.

In step S1111, the service server 20 may calculate a group streaming index of a first group artist with respect to the target city based on streaming data from a plurality of streaming servers corresponding to the information providing server 10.

Here, the first group artist is composed of one or more member artists, and the one or more member artists may include a first member artist who is the first promising artist. The streaming data may be data related to statistics of the streaming history of the streaming server for the first group artist, and the group streaming index may be a streaming index for the first group artist.

Specifically, the service server 20 may calculate at least one streaming indicator among a group music streaming indicator and a group video streaming indicator of the first group artist, and may calculate the group streaming index based on the at least one streaming indicator.

Here, the group music streaming indicator may be related to music tracks and/or music albums of the first group artist with respect to a specific date and the target city, and may be calculated based on streaming data from two or more first streaming servers among the plurality of streaming servers that provide music streaming services. In addition, the group video streaming indicator may be related to videos of the first group artist with respect to a specific date and the target city, and may be calculated based on streaming data from one or more second streaming servers among the plurality of streaming servers that provide video streaming services. When both the group music streaming indicator and the group video streaming indicator are used, the service server 20 may calculate the total sum or weighted sum of the group music streaming indicator and the group video streaming indicator as the group streaming index.

More specifically, the service server 20 may calculate the group music streaming indicator based on at least one of the first, second, and third group music streaming indicators.

Here, the first group music streaming indicator may be related to the number of listeners who have listened to music tracks of the first group artist in the target city up to a specific date. As an example, the calculation server 20 may calculate the first group music streaming indicator based on the sum of the number of listeners in the target city on a monthly basis up to a specific date. In addition, the second group music streaming indicator may be related to the number of music tracks of the first group artist listed on the music chart of the target city up to a specific date, and the third group music streaming indicator may be related to the number of music albums of the first group artist listed on the music chart of the target city up to a specific date.

In addition, the service server 20 may calculate the group video streaming indicator based on the number of views for videos of the first group artist up to a specific date. Here, the videos of the first group artist may be videos produced by a video creator based in the target city based on the music tracks of the first group artist. That is, the video creator may be a creator residing in the target city. The number of views may be aggregated for viewers worldwide.

In step S1112, the service server 20 may calculate a fandom index of the first promising artist for a specific date and the target city based on log data.

As described above, log data corresponding to online fandom activities may be stored in the storage unit 24, and the service server 20 may calculate a fandom index of the first promising artist for a specific date and the first city based on the log data.

Specifically, the service server 20 may calculate the fandom index based on at least one of first and second fandom indicators. The first fandom indicator may be related to popularity voting for the first promising artist in the target city conducted on the service server 20. Here, the popularity vote may be a free popularity vote and may include a preliminary popularity vote and a main popularity vote. The value of the popularity vote may be the cumulative value of the popularity votes for the first promising artist up to a specific date. In addition, the second fandom indicator may be related to information about payments made by fans based in the target city for goods related to the first promising artist. Here, goods may include fan goods, concert tickets, participation in paid popularity voting, etc. of the first promising artist. For example, payment information may be information about payment for goods using digital assets sold for a fee on the service server 20. As another example, payment information may be information about direct payment for goods using a credit card or the like through the service server 20.

In step S1113, the service server 20 may set a group streaming weight and a fandom weight.

Here, the group streaming weight is a weight related to the group streaming index and may have any value between 0 and 1. The group streaming weight may be set based on whether the first group artist performs group activities within a predetermined specific period and the number of member artists included in the first group artist. In addition, the fandom weight is a weight related to the fandom index and may have any value between 0 and 1, and may be set to a specific fixed value (for example, a third value).

According to the first embodiment, when the first group artist is composed of two or more member artists including the first promising artist and the first group artist performs group activities within a specific period, the service server 20 may set the group streaming weight to have a first value corresponding to the contribution of the first promising artist to the first group artist.

Specifically, in step S1112, the service server 20 may further calculate the fandom index of other member artists of the first group artist for a specific date and the target city based on the log data. The fandom index of the other member artists may be calculated similarly to the fandom index of the first promising artist described above. In this case, in step S1113, the service server may calculate the first value based on the fandom index for each member artist belonging to the first group artist. According to an embodiment, the service server 20 may set the ratio of the fandom index of the first promising artist to the sum or weighted sum of the fandom index for each member artist belonging to the first group artist as the first value.

According to the second embodiment, when the first group artist is a solo artist including only the first promising artist, the service server 20 may set the group streaming weight to have a preset second value. In this case, the second value may have a fixed value.

According to the third embodiment, when the first group artist is composed of two or more member artists including the first promising artist but the first group artist does not perform group activities during a specific period, the service server 20 may set the group streaming weight to have the second value. That is, since the above-described first promising artist is essentially a solo artist, the same group streaming weight as that of a solo artist may be assigned.

In step S1114, the service server 20 may calculate the first popularity index of the first promising artist for a specific date and the target city based on the group streaming index of the first group artist, the group streaming weight of the first promising artist, the fandom index, and the fandom weight.

According to an embodiment, the service server 20 may calculate the first popularity index of the first member artist based on a computed value A obtained by multiplying the group streaming weight of the first member artist and the group streaming index of the first group artist, and a computed value B obtained by multiplying the fandom weight and the fandom index of the first promising artist.

Meanwhile, there may be cases in which the first group artist is composed of two or more member artists including the first promising artist, and the first group artist performs group activities while the first promising artist also performs individual activities within a specific period. In this case, the streaming index related to the individual activities of the first promising artist must be included in the first popularity index of the first promising artist. Therefore, the service server may further calculate the member streaming index of the first promising artist who performs individual activities, further set a member streaming weight related to the member streaming index, and calculate the first popularity index of the first promising artist further based on the member streaming index and the member streaming weight.

Specifically, in step S1111, the service server 20 may further calculate the member streaming index of the first promising artist for a specific date and the target city based on streaming data from the plurality of streaming servers. Here, the member streaming index may be calculated similarly to the group streaming index described above.

Thereafter, in step S1113, the service server 20 may further set the member streaming weight. In this case, the member streaming weight has any value between 0 and 1, and may be set in particular to the second value. Meanwhile, the group streaming weight may be set to the first value corresponding to the above-described contribution.

Finally, in step S1114, the service server 20 may calculate the first popularity index of the first promising artist further based on the member streaming index and the member streaming weight.

According to an embodiment, the service server 20 may calculate a first computed value based on the first average value of the group streaming weight and the member streaming weight and the second average value of the group streaming index and the member streaming index, may calculate a third computed value based on the fandom weight and the fandom index, and may calculate the first popularity index based on the first and third computed values.

According to another embodiment, the service server 20 may calculate a second computed value based on the first multiplication computed value of the group streaming weight and the group streaming index and the second multiplication computed value of the member streaming weight and the member streaming index, may calculate a third computed value based on the fandom weight and the fandom index, and may calculate the first popularity index based on the second and third computed values.

Referring back to FIG. 4, in step S112, the service server 20 may calculate a second popularity index of the first promising artist with respect to the target city.

Here, the second popularity index of the first promising artist may correspond to the similarity between the popular artist in the target city and the first promising artist, and may reflect the artist popularity trend of the target city. That is, the second popularity index of the first promising artist may correspond to a predicted popularity index indicating how popular the first promising artist can become compared to the popular artist.

Step S112 will now be described in more detail.

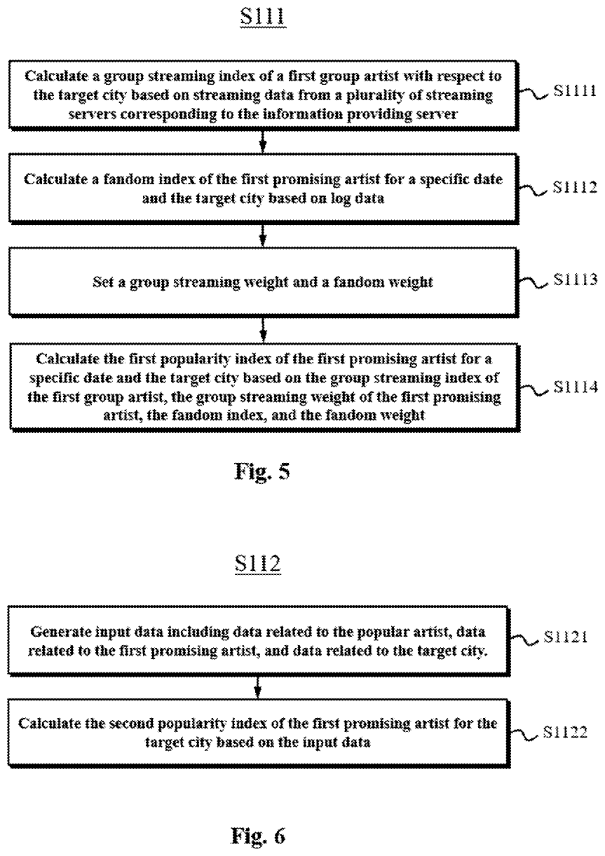

FIG. 6 is a diagram showing a detailed flowchart of step S112 among the steps of FIG. 4.

In step S1121, the service server 20 may generate input data including data related to the popular artist, data related to the first promising artist, and data related to the target city.

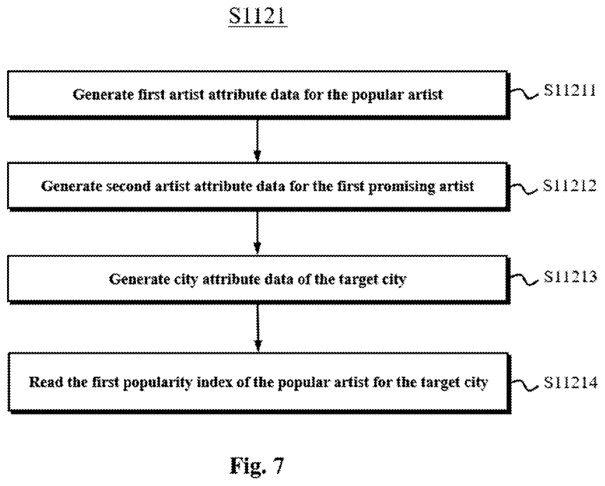

FIG. 7 is a diagram showing a detailed flowchart of step S1121 among the steps of FIG. 6.

First, in step S11211, the service server 20 may generate first artist attribute data for the popular artist. Here, the first artist attribute data may include profile data and facial data.

According to an embodiment, the profile data of the popular artist may include one or more profile variables corresponding to at least one of the age, gender, height, nationality, languages spoken, personality type, position within the group artist, solo activity information, and characteristic information evaluated by fans of the popular artist.

Here, age may be defined as a concept including date of birth, personality type May correspond to MBTI (Myers-Briggs Type Indicator), and position within the group artist may correspond to the role the popular artist plays within the group artist. In addition, solo activity information is information about whether the artist performs individual activities separately from group activities of the group artist, and may include whether the artist performs solo activities and the number of solo albums. The characteristic information evaluated by fans is information evaluated by fans of the popular artist about the popular artist, and may include concept evaluation (e.g., innocence, elegance, coldness), personality evaluation (e.g., playfulness, entertainment sense), etc.

Meanwhile, in step S11211, the service server 20 may perform a preprocessing process on raw profile data of the popular artist obtained from the information providing server 10 to generate profile data of the popular artist.

Here, the raw profile data may include one or more numerical raw profile variables and one or more categorical raw profile variables. In this case, the service server 20 may perform a preprocessing process on numerical raw profile variables by standardizing or normalizing them. In addition, the service server 20 may perform a preprocessing process on categorical raw profile variables by converting them into numerical variables. In this case, one-hot encoding may be used in the preprocessing process for categorical raw profile variables.

In addition, according to an embodiment, the facial data of the popular artist may include a plurality of facial variables related to facial features of the popular artist. Here, the plurality of facial variables may correspond to a plurality of vector elements included in a facial feature vector (i.e., facial embedding vector).

Meanwhile, in step S11211, the service server 20 may extract a facial region from an image of the popular artist (Face Detection process), may extract a plurality of landmarks from the facial region (Alignment process), may rotate the facial region based on the plurality of landmarks (Normalization process), and then may calculate a plurality of facial variables corresponding to a multi-dimensional facial feature vector (Representation process). In this case, when a plurality of images of the popular artist are used, the a-th facial variable among the plurality of facial variables may correspond to the average value of the a-th element of the facial embedding vector for each image.

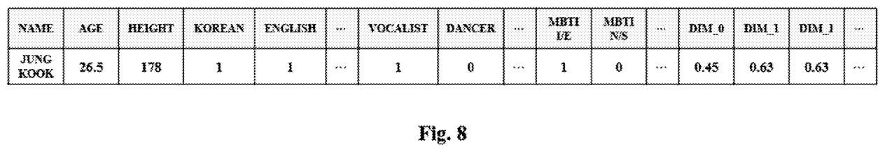

First artist attribute data of the popular artist may be generated according to the above-described content. FIG. 8 shows an example of the first artist attribute data of the popular artist.

Next, in step S11212, the service server 20 may generate second artist attribute data for the first promising artist. Here, the second artist attribute data may also include profile data and facial data.

Since the process of step S11212 is almost the same as that of step S11211, duplicate description will be omitted.

Continuing, in step S11213, the service server 20 may generate city attribute data of the target city. Here, the city attribute data may be used to analyze the artist popularity trend of the target city.

According to an embodiment, the city attribute data may include one or more city variables corresponding to at least one of the country and continent to which the target city belongs, whether the target city is a capital, population, ethnic information, religious information, and economic indicator information.

Here, ethnic information may correspond to the population or proportion by ethnicity of citizens residing in the target city, religious information may correspond to the number or proportion of believers by religion of citizens residing in the target city, and economic indicator information may correspond to income/distribution indicators such as GDP and GINI index.

Meanwhile, in step S11213, the service server 20 may perform a preprocessing process on raw city attribute data of the target city obtained from the information providing server 10 to generate city attribute data of the target city. In this case, similarly to the above, the raw city attribute data may include one or more numerical raw city variables and one or more categorical raw city variables, and a preprocessing process for categorical raw city variables may be performed by converting the categorical raw city variables into numerical variables.

Finally, in step S11214, the service server 20 may read the first popularity index of the popular artist for the target city from the storage unit 24.

As described above, the first popularity index for each of some artists may be calculated in advance and stored in the storage unit 24, and the service server 20 may read the first popularity index of the popular artist from among the first popularity index for each of some artists.

Referring back to FIG. 6, in step S1122, the service server 20 may calculate the second popularity index of the first promising artist for the target city based on the input data.

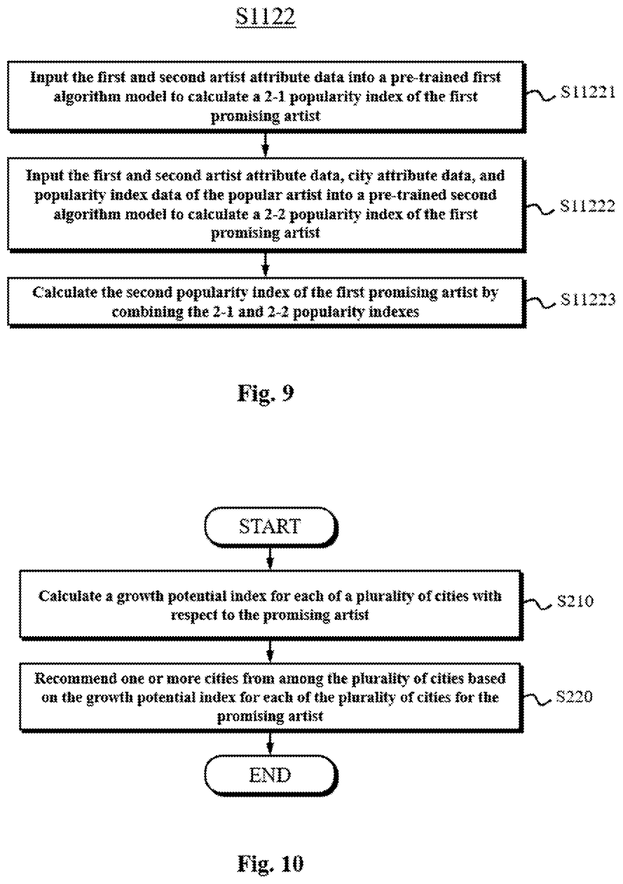

Step S1122 will now be described in detail with reference to FIG. 9.

FIG. 9 is a diagram showing a detailed flowchart of step S1122 among the steps of FIG. 3.

First, in step S11221, the service server 20 may input the first and second artist attribute data into a pre-trained first algorithm model to calculate a 2-1 popularity index of the first promising artist.

Here, the 2-1 popularity index may be an index reflecting the similarity between the popular artist and the first promising artist.

According to an embodiment, the service server 20 may generate a plurality of first merged attribute variables obtained by merging a plurality of first attribute variables included in the first artist attribute data and a plurality of second attribute variables included in the second artist attribute data, and may input the generated plurality of first merged attribute variables into the first algorithm model to calculate the 2-1 popularity index.

Specifically, the plurality of first attribute variables may be one or more profile variables of the popular artist included in the first artist attribute data and a plurality of facial variables of the popular artist. In addition, the plurality of second attribute variables may be one or more profile variables of the first promising artist included in the second artist attribute data and a plurality of facial variables of the promising artist. The plurality of first merged attribute variables may be generated by merging the plurality of first attribute variables and the plurality of second attribute variables according to preset conditions. For example, when the plurality of first attribute variables are “(x_popular1, x_popular2, . . . , x_popularm)” and the plurality of second attribute variables are “(x_promising1, x_promising2, . . . , x_promisingm)”, the plurality of first merged attribute variables may be expressed as “(x_popular1, x_popular2, . . . , x_popularm, x_promising1, x_promising2, . . . , x_promisingm)”.

More specifically, the service server 20 may apply the plurality of first merged attribute variables to Equation 1 below corresponding to the first algorithm model to calculate the 2-1 popularity index.

$$y = {w}_{0} + {\sum }_{i = 1}^{n} {w}_{i} {X}_{i} , + {{\sum }_{i = 1}}^{n} {{\sum }_{j = i + 1}}^{n} 〈 {v}_{i} , {v}_{j} 〉 {X}_{i} {X}_{j} \qquad [ Equation 1 ]$$

Here, y is the 2-1 popularity index, i and j are indexes of the first merged attribute variables, n is the number of first merged attribute variables, Xi and Xj are first merged attribute variables, w0 and wi are pre-trained and set coefficients, vi is a pre-trained and set latent vector of Xi, vj is a pre-trained and set latent vector of Xj, and < > denotes a dot product operation.

Meanwhile, referring to Equation 1, the first popularity potential index may correspond to the inter-artist similarity reflecting the interaction between a plurality of first merged attribute variables.

Next, in step S11222, the service server 20 may input the first and second artist attribute data, city attribute data, and popularity index data of the popular artist into a pre-trained second algorithm model to calculate a 2-2 popularity index of the first promising artist.

Here, the 2-2 popularity index may be an index that further reflects the artist popularity trend in the target city.

According to an embodiment, the service server 20 may generate a plurality of second merged attribute variables obtained by merging the above-described plurality of first and second attribute variables, one or more third attribute variables included in the city attribute data, and a fourth attribute variable corresponding to the first popularity index of the popular artist with respect to the target city, and may input the generated plurality of second merged attribute variables into the second algorithm model to calculate the 2-2 popularity index.

Specifically, the plurality of first and second attribute variables have been described above. In addition, the third attribute variable may be one or more city variables included in the city attribute data. The plurality of second merged attribute variables may be generated by merging the plurality of first and second attribute variables, one or more third attribute variables, and the fourth attribute variable according to preset conditions. For example, when the first attribute variable is “(x_popular1, x_popular2, . . . , x_popularm)”, the second attribute variable is “(x_promising1, x_promising2, . . . , x_promisingm)”, the third attribute variable is “(x_city1, x_city2, . . . , x_cityp)”, and the fourth attribute variable is “(x_popularityindex)”, the plurality of second merged attribute variables may be expressed as “(x_popular1, x_popular2, . . . , x_popularm, x_promising1, x_promising2, x_promisingm, x_city1, x_city2, . . . , x_cityp, x_popularityindex)”.

In addition, the second algorithm model may be an artificial neural network-based algorithm model. In this case, the artificial neural network-based algorithm model may have the structure of Multi-Layer Neural Networks and may be a DNN (Deep Neural Network) model including an input layer, two or more hidden layers, and an output layer. The input layer is a layer that accepts external data, and the number of neurons in the input layer is equal to the number of input variables. The hidden layers are located between the input layer and the output layer, and receive signals from the input layer to extract features and transmit them to the output layer. The output layer receives signals from the hidden layers and outputs output values based on the received signals. Input signals between neurons are multiplied by their respective weights (connection strengths) and then summed, and if this sum exceeds the neuron's threshold, the neuron is activated and outputs the output value obtained through the activation function.

Referring to the above description, the input layer may receive a plurality of second merged attribute variables as input, two or more hidden layers may generate a latent vector reflecting the nonlinear interactions of the plurality of second merged attribute variables, and the output layer may output the second popularity potential index based on the latent vector. In this case, each of the two or more hidden layers may calculate an output value as shown in Equation 2 below.

$${H}^{( L )} = f ( {W}^{( L )} {H}^{( L - 1 )} + {b}^{( L )} ) \qquad [ Equation 2 ]$$

Here, H(L) is the output value of the L-th hidden layer, W(L) is the weight matrix of the L-th hidden layer, H(L−1) is the output value of the (L−1)-th hidden layer, b(L) is the bias vector of the L-th hidden layer, and f( ) is an activation function with nonlinearity.

Meanwhile, referring to Equation 2, the second popularity potential index may correspond to the similarity reflecting the trend of the target city according to the nonlinear interactions between the plurality of second merged attribute variables.

Finally, in step S11223, the service server 20 may calculate the second popularity index of the first promising artist by combining the 2-1 and 2-2 popularity indexes.

According to an embodiment, the service server 20 may calculate the second popularity index of the first promising artist by summing the 2-1 and 2-2 popularity indexes. According to another embodiment, the service server 20 may calculate the second popularity index of the first promising artist by summing the 2-1 and 2-2 popularity indexes and then performing a sigmoid transformation.

In summary, the service server 20 may predict the 2-1 popularity index corresponding to the profile and facial similarity between the popular artist and the first promising artist, and then adjust or correct the 2-1 popularity index with the 2-2 popularity index reflecting the artist popularity trend of the target city to calculate the second popularity index corresponding to the probability that the first promising artist will succeed in the target city.

Meanwhile, in FIG. 6 and the like, the content of calculating the growth potential index of the first promising artist based on one popular artist in the target city has been described. However, there may be a plurality of popular artists in the target city. In this case, the service server 20 may calculate a plurality of second popularity indexes for the first promising artist by performing the steps of FIG. 6 for each of the plurality of popular artists, and may calculate the maximum value among the plurality of second popularity indexes as the second popularity index of the first promising artist.

Referring back to FIG. 4, in step S113, the service server 20 may calculate the growth potential index of the first promising artist with respect to the target city based on the first and second popularity indexes of the first promising artist.

In this case, as described above, the growth potential index of the first promising artist may be defined as a measure indicating how much more popular the first promising artist will grow in the target city in the future.

According to an embodiment, the growth potential index of the first promising artist may be a relationship value between the second popularity index of the first promising artist and the first popularity index of the first promising artist.

As one example, the relationship value may correspond to the difference value between the second popularity index of the first promising artist and the first popularity index of the first promising artist. As another example, the relationship value may correspond to the ratio value of the second popularity index of the first promising artist to the first popularity index of the first promising artist.

That is, the first popularity index of the first promising artist may correspond to the actual popularity of the first promising artist in the target city, and the second popularity index of the first promising artist may correspond to the predicted popularity indicating how popular the first promising artist can become compared to the popular artist. Accordingly, by calculating the relationship value (e.g., difference value) between the predicted popularity (i.e., second popularity index) and the actual popularity (i.e., first popularity index) of the first promising artist, the growth potential index—a measure indicating how much more popular the first promising artist will grow in the target city in the future—can be efficiently derived.

Referring back to FIG. 3, in step S120, the service server 20 may recommend one or more promising artists based on the growth potential index for each of the plurality of promising artists.

According to an embodiment, the service server 20 may select and recommend the top N (integer of 1 or more) promising artists with the highest growth potential index from among the plurality of promising artists. According to another embodiment, the service server 20 may select and recommend N promising artists whose growth potential index is higher than a preset threshold value from among the plurality of promising artists. In addition, various recommendation methods in various embodiments may be used in addition to the above-described recommendation methods.

In summary, the recommendation method according to an embodiment of the present invention can efficiently calculate the growth potential index of a promising artist—a measure indicating how much more popular the promising artist will grow in the target city in the future—by comparing the actual popularity (i.e., first popularity index) and the predicted popularity (i.e., second popularity index) of the promising artist in the target city.

In addition, by utilizing the growth potential index for each of the plurality of promising artists, when an event such as a concert or festival is scheduled to be held in the target city, one or more promising artists suitable for the cultural characteristics and artist preferences of the target city can be effectively engaged. Through the successful hosting of events, the city's economy can be revitalized and opportunities for citizens to enjoy culture can be provided.

Hereinafter, a method for recommending a city for a promising artist, which is performed by the processor 23 of the service server 20, will be described in detail with reference to FIG. 10 and the like.

FIG. 10 is a diagram showing an overall flowchart of a method for recommending a promising artist in a target city according to an embodiment of the present invention.

The steps of FIG. 10 will be described in detail below.

In step S210, the service server 20 may calculate a growth potential index for each of a plurality of cities with respect to the promising artist.

As described above, a promising artist may refer to an artist who is not yet widely known in each of the plurality of cities. The growth potential index of the promising artist for each of the plurality of cities may be defined as a measure indicating how much more popular the promising artist will grow in the corresponding city in the future.

According to an embodiment, for each of the plurality of cities, the service server 20 may calculate the growth potential index of the promising artist based on the actual popularity of the promising artist and an attribute comparison between the popular artist of the corresponding city and the promising artist. Here, the popular artist of the corresponding city refers to an artist who is already well-known in that city, and the attribute comparison may correspond to the similarity between the popular artist and the promising artist.

Step S210 will be described in detail below.

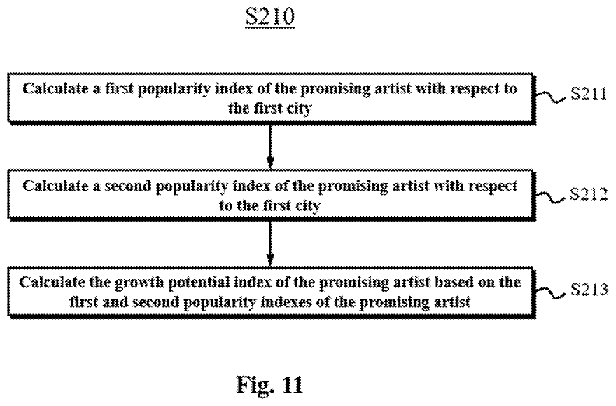

FIG. 11 is a diagram showing a detailed flowchart of step S210 among the steps of FIG. 10.

Here, the steps shown in FIG. 11 represent steps for calculating the growth potential index of the promising artist for a first city among a plurality of cities. These steps of FIG. 11 may be equally applied to cities other than the first city. Meanwhile, the steps shown in FIG. 11 may also constitute a separate method for calculating the growth potential index of the promising artist in a specific city.

In step S211, the service server 20 may calculate a first popularity index of the promising artist with respect to the first city.

Here, the first popularity index of the promising artist may correspond to the actual popularity of the promising artist in the first city.

According to an embodiment, the first popularity index may be a total popularity index, which is the actual popularity index of the promising artist up to a specific date. Here, the total popularity index may correspond to the cumulative popularity index, long-term popularity index, career popularity index, overall popularity index, etc. of the promising artist. However, the present invention is not limited thereto, and the first popularity index may be a current popularity index, which is the actual popularity index of the promising artist on a specific date itself. Here, the current popularity index may correspond to the short-term popularity index, recent popularity index, etc. of the promising artist. Hereinafter, the first popularity index is assumed to be the total popularity index in describing this embodiment.

Meanwhile, the first popularity index of the popular artist may be stored in the storage unit 24 after step S211 has been performed in advance. For example, a popular artist may be an artist having a ratio of the first popularity index in the upper rank among a plurality of artists active or scheduled to be active in the first city.

Step S211 will now be described in more detail.

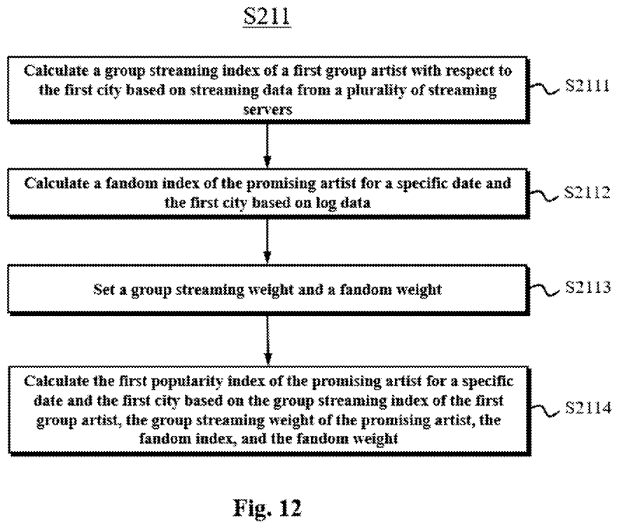

FIG. 12 is a diagram showing a detailed flowchart of step S211 among the steps of FIG. 11.

In step S2111, the service server 20 may calculate a group streaming index of a first group artist with respect to the first city based on streaming data from a plurality of streaming servers corresponding to the information providing server 10.

Here, the first group artist is composed of one or more member artists, and the one or more member artists may include a first member artist who is the promising artist. The streaming data may be data related to statistics of the streaming history of the streaming server for the first group artist, and the group streaming index may be a streaming index for the first group artist.

Specifically, the service server 20 may calculate at least one streaming indicator among a group music streaming indicator and a group video streaming indicator of the first group artist, and may calculate the group streaming index based on the at least one streaming indicator.

Here, the group music streaming indicator may be related to music tracks and/or music albums of the first group artist with respect to a specific date and the first city, and may be calculated based on streaming data from two or more first streaming servers among the plurality of streaming servers that provide music streaming services. In addition, the group video streaming indicator may be related to videos of the first group artist with respect to a specific date and the first city, and may be calculated based on streaming data from one or more second streaming servers among the plurality of streaming servers that provide video streaming services. When both the group music streaming indicator and the group video streaming indicator are used, the service server 20 may calculate the total sum or weighted sum of the group music streaming indicator and the group video streaming indicator as the group streaming index.

More specifically, the service server 20 may calculate the group music streaming indicator based on at least one of the first, second, and third group music streaming indicators.

Here, the first group music streaming indicator may be related to the number of listeners who have listened to music tracks of the first group artist in the first city up to a specific date. As an example, the calculation server 20 may calculate the first group music streaming indicator based on the sum of the number of listeners in the first city on a monthly basis up to a specific date. In addition, the second group music streaming indicator may be related to the number of music tracks of the first group artist listed on the music chart of the first city up to a specific date, and the third group music streaming indicator may be related to the number of music albums of the first group artist listed on the music chart of the first city up to a specific date.

In addition, the service server 20 may calculate the group video streaming indicator based on the number of views for videos of the first group artist up to a specific date. Here, the videos of the first group artist may be videos produced by a video creator based in the first city based on the music tracks of the first group artist. That is, the video creator may be a creator residing in the first city. The number of views may be aggregated for viewers worldwide.

In step S2112, the service server 20 may calculate a fandom index of the promising artist for a specific date and the first city based on log data.

As described above, log data corresponding to online fandom activities may be stored in the storage unit 24, and the service server 20 may calculate a fandom index of the promising artist for a specific date and the first city based on the log data.

Specifically, the service server 20 may calculate the fandom index based on at least one of first and second fandom indicators. The first fandom indicator may be related to popularity voting for the promising artist in the first city conducted on the service server 20. Here, the popularity vote may be a free popularity vote and may include a preliminary popularity vote and a main popularity vote. The value of the popularity vote may be the cumulative value of the popularity votes for the promising artist up to a specific date. In addition, the second fandom indicator may be related to information about payments made by fans based in the first city for goods related to the promising artist. Here, goods may include fan goods, concert tickets, participation in paid popularity voting, etc. of the promising artist. For example, payment information may be information about payment for goods using digital assets sold for a fee on the service server 20. As another example, payment information may be information about direct payment for goods using a credit card or the like through the service server 20.

In step S2113, the service server 20 may set a group streaming weight and a fandom weight.

Here, the group streaming weight is a weight related to the group streaming index and may have any value between 0 and 1. The group streaming weight may be set based on whether the first group artist performs group activities within a predetermined specific period and the number of member artists included in the first group artist. In addition, the fandom weight is a weight related to the fandom index and may have any value between 0 and 1, and may be set to a specific fixed value (for example, a third value).

According to the first embodiment, when the first group artist is composed of two or more member artists including the promising artist and the first group artist performs group activities within a specific period, the service server 20 may set the group streaming weight to have a first value corresponding to the contribution of the promising artist to the first group artist.

Specifically, in step S2112, the service server 20 may further calculate the fandom index of other member artists of the first group artist for a specific date and the first city based on the log data. The fandom index of the other member artists may be calculated similarly to the fandom index of the promising artist described above. In this case, in step S2113, the service server 20 may calculate the first value based on the fandom index for each member artist belonging to the first group artist. According to an embodiment, the service server 20 may set the ratio of the fandom index of the promising artist to the sum or weighted sum of the fandom index for each member artist belonging to the first group artist as the first value.

According to the second embodiment, when the first group artist is a solo artist including only the promising artist, the service server 20 may set the group streaming weight to have a preset second value. In this case, the second value may have a fixed value.

According to the third embodiment, when the first group artist is composed of two or more member artists including the promising artist but the first group artist does not perform group activities during a specific period, the service server 20 may set the group streaming weight to have the second value. That is, since the above-described promising artist is essentially a solo artist, the same group streaming weight as that of a solo artist may be assigned.

In step S2114, the service server 20 may calculate the first popularity index of the promising artist for a specific date and the first city based on the group streaming index of the first group artist, the group streaming weight of the promising artist, the fandom index, and the fandom weight.

According to an embodiment, the service server 20 may calculate the first popularity index of the first member artist based on a computed value A obtained by multiplying the group streaming weight of the first member artist and the group streaming index of the first group artist, and a computed value B obtained by multiplying the fandom weight and the fandom index of the promising artist.

Meanwhile, there may be cases in which the first group artist is composed of two or more member artists including the promising artist, and the first group artist performs group activities while the promising artist also performs individual activities within a specific period. In this case, the streaming index related to the individual activities of the promising artist must be included in the first popularity index of the promising artist. Therefore, the service server 20 may further calculate the member streaming index of the promising artist who performs individual activities, further set a member streaming weight related to the member streaming index, and calculate the first popularity index of the promising artist further based on the member streaming index and the member streaming weight.

Specifically, in step S2111, the service server 20 may further calculate the member streaming index of the promising artist for a specific date and the first city based on streaming data from the plurality of streaming servers. Here, the member streaming index may be calculated similarly to the group streaming index described above.

Thereafter, in step S2113, the service server 20 may further set the member streaming weight. In this case, the member streaming weight has any value between 0 and 1, and may be set in particular to the second value. Meanwhile, the group streaming weight may be set to the first value corresponding to the above-described contribution.

Finally, in step S2114, the service server 20 may calculate the first popularity index of the promising artist further based on the member streaming index and the member streaming weight.

According to an embodiment, the service server 20 may calculate a first computed value based on the first average value of the group streaming weight and the member streaming weight and the second average value of the group streaming index and the member streaming index, may calculate a third computed value based on the fandom weight and the fandom index, and may calculate the first popularity index based on the first and third computed values.

According to another embodiment, the service server 20 may calculate a second computed value based on the first multiplication computed value of the group streaming weight and the group streaming index and the second multiplication computed value of the member streaming weight and the member streaming index, may calculate a third computed value based on the fandom weight and the fandom index, and may calculate the first popularity index based on the second and third computed values.

Referring back to FIG. 11, in step S212, the service server 20 may calculate a second popularity index of the promising artist with respect to the first city.

Here, the second popularity index of the promising artist may correspond to the similarity between the popular artist in the first city and the promising artist, and may reflect the artist popularity trend of the first city. That is, the second popularity index of the promising artist may correspond to a predicted popularity index indicating how popular the promising artist can become compared to the popular artist.

Step S212 will now be described in more detail.

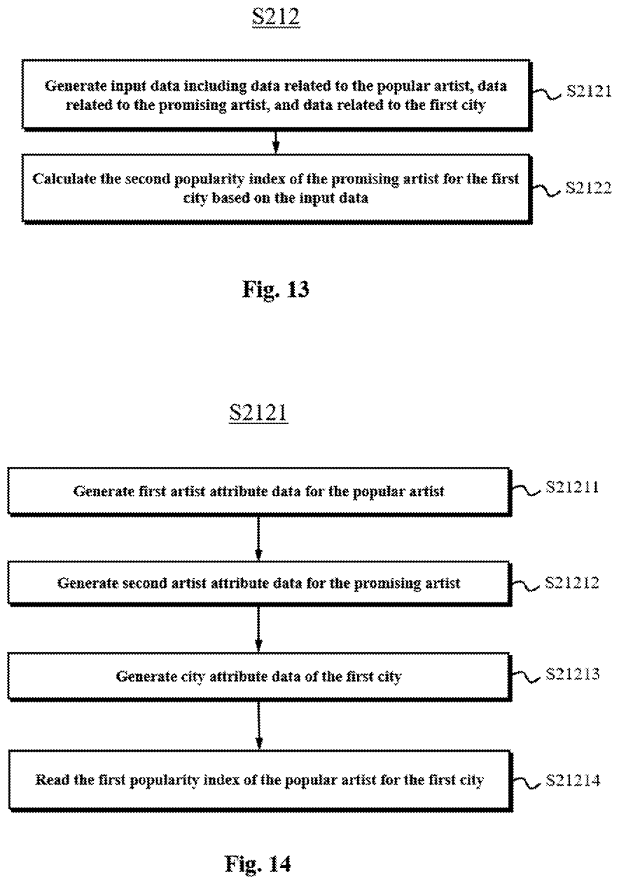

FIG. 13 is a diagram showing a detailed flowchart of step S212 among the steps of FIG. 11.

In step S2121, the service server 20 may generate input data including data related to the popular artist, data related to the promising artist, and data related to the first city.

FIG. 14 is a diagram showing a detailed flowchart of step S2121 among the steps of FIG. 13.

First, in step S21211, the service server 20 may generate first artist attribute data for the popular artist. Here, the first artist attribute data may include profile data and facial data.

According to an embodiment, the profile data of the popular artist may include one or more profile variables corresponding to at least one of the age, gender, height, nationality, languages spoken, personality type, position within the group artist, solo activity information, and characteristic information evaluated by fans of the popular artist.

Here, age may be defined as a concept including date of birth, personality type may correspond to MBTI (Myers-Briggs Type Indicator), and position within the group artist may correspond to the role the popular artist plays within the group artist. In addition, solo activity information is information about whether the artist performs individual activities separately from group activities of the group artist, and may include whether the artist performs solo activities and the number of solo albums. The characteristic information evaluated by fans is information evaluated by fans of the popular artist about the popular artist, and may include concept evaluation (e.g., innocence, elegance, coldness), personality evaluation (e.g., playfulness, entertainment sense), etc.

Meanwhile, in step S21211, the service server 20 may perform a preprocessing process on raw profile data of the popular artist obtained from the information providing server 10 to generate profile data of the popular artist.

Here, the raw profile data may include one or more numerical raw profile variables and one or more categorical raw profile variables. In this case, the service server 20 may perform a preprocessing process on numerical raw profile variables by standardizing or normalizing them. In addition, the service server 20 may perform a preprocessing process on categorical raw profile variables by converting them into numerical variables. In this case, one-hot encoding may be used in the preprocessing process for categorical raw profile variables.

In addition, according to an embodiment, the facial data of the popular artist may include a plurality of facial variables related to facial features of the popular artist. Here, the plurality of facial variables may correspond to a plurality of vector elements included in a facial feature vector (i.e., facial embedding vector).

Meanwhile, in step S21211, the service server 20 may extract a facial region from an image of the popular artist (Face Detection process), may extract a plurality of landmarks from the facial region (Alignment process), may rotate the facial region based on the plurality of landmarks (Normalization process), and then may calculate a plurality of facial variables corresponding to a multi-dimensional facial feature vector (Representation process). In this case, when a plurality of images of the popular artist are used, the a-th facial variable among the plurality of facial variables may correspond to the average value of the a-th element of the facial embedding vector for each image.

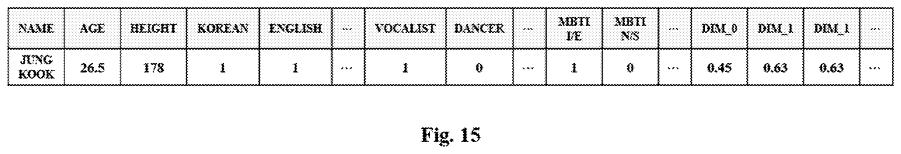

First artist attribute data of the popular artist may be generated according to the above-described content. FIG. 15 shows an example of the first artist attribute data of the popular artist.

Next, in step S21212, the service server 20 may generate second artist attribute data for the promising artist. Here, the second artist attribute data may also include profile data and facial data.

Since the process of step S21212 is almost the same as that of step S21211, duplicate description will be omitted.

Continuing, in step S21213, the service server 20 may generate city attribute data of the first city. Here, the city attribute data may be used to analyze the artist popularity trend of the first city.

According to an embodiment, the city attribute data may include one or more city variables corresponding to at least one of the country and continent to which the first city belongs, whether the first city is a capital, population, ethnic information, religious information, and economic indicator information.

Here, ethnic information may correspond to the population or proportion by ethnicity of citizens residing in the first city, religious information may correspond to the number or proportion of believers by religion of citizens residing in the first city, and economic indicator information may correspond to income/distribution indicators such as GDP and GINI index.

Meanwhile, in step S21213, the service server 20 may perform a preprocessing process on raw city attribute data of the first city obtained from the information providing server 10 to generate city attribute data of the first city. In this case, similarly to the above, the raw city attribute data may include one or more numerical raw city variables and one or more categorical raw city variables, and a preprocessing process for categorical raw city variables may be performed by converting the categorical raw city variables into numerical variables.

Finally, in step S21214, the service server 20 may read the first popularity index of the popular artist for the first city from the storage unit 24.

As described above, the first popularity index for each of some artists may be calculated in advance and stored in the storage unit 24, and the service server 20 may read the first popularity index of the popular artist from among the first popularity index for each of some artists.

Referring back to FIG. 13, in step S2122, the service server 20 may calculate the second popularity index of the promising artist for the first city based on the input data.

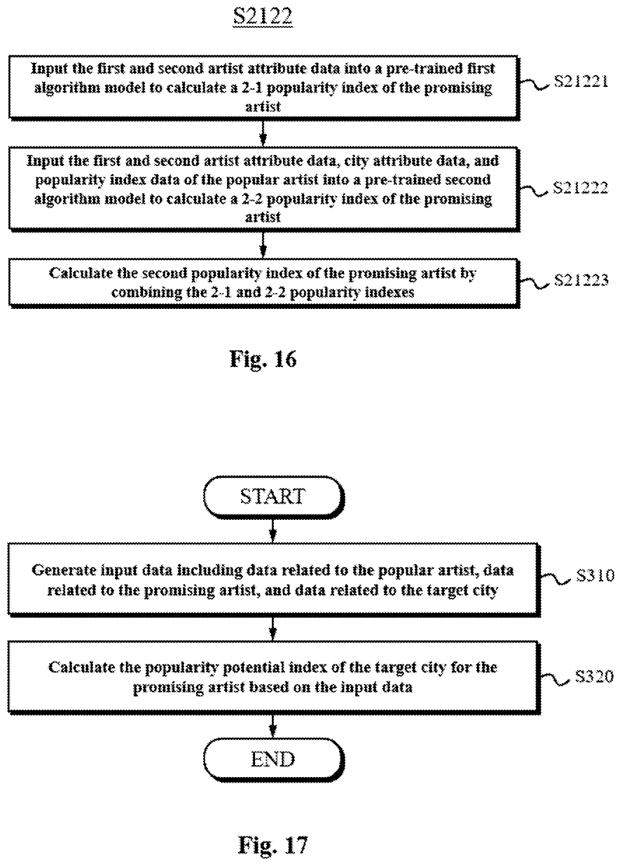

Step S2122 will now be described in detail with reference to FIG. 16.

FIG. 16 is a diagram showing a detailed flowchart of step S2122 among the steps of FIG. 10.

First, in step S21221, the service server 20 may input the first and second artist attribute data into a pre-trained first algorithm model to calculate a 2-1 popularity index of the promising artist.

Here, the 2-1 popularity index may be an index reflecting the similarity between the popular artist and the promising artist.

According to an embodiment, the service server 20 may generate a plurality of first merged attribute variables obtained by merging a plurality of first attribute variables included in the first artist attribute data and a plurality of second attribute variables included in the second artist attribute data, and may input the generated plurality of first merged attribute variables into the first algorithm model to calculate the 2-1 popularity index.

Specifically, the plurality of first attribute variables may be one or more profile variables of the popular artist included in the first artist attribute data and a plurality of facial variables of the popular artist. In addition, the plurality of second attribute variables may be one or more profile variables of the promising artist included in the second artist attribute data and a plurality of facial variables of the promising artist. The plurality of first merged attribute variables may be generated by merging the plurality of first attribute variables and the plurality of second attribute variables according to preset conditions. For example, when the plurality of first attribute variables are “(x_popular1, x_popular2, . . . , x_popularm)” and the plurality of second attribute variables are “(x_promising1, x_promising2, . . . , x_promisingm)”, the plurality of first merged attribute variables may be expressed as “(x_popular1, x_popular2, . . . , x_popularm, x_promising1, x_promising2, . . . , x_promisingm)”.

More specifically, the service server 20 may apply the plurality of first merged attribute variables to Equation 3 below corresponding to the first algorithm model to calculate the 2-1 popularity index.

$$y = {w}_{0} + {\sum }_{i = 1}^{n} {w}_{i} {X}_{i} , + {{\sum }_{i = 1}}^{n} {{\sum }_{j = i + 1}}^{n} 〈 {v}_{i} , {v}_{j} 〉 {X}_{i} {X}_{j} \qquad [ Equation 3 ]$$

Here, y is the 2-1 popularity index, i and j are indexes of the first merged attribute variables, n is the number of first merged attribute variables, Xi and Xj are first merged attribute variables, w0 and wi are pre-trained and set coefficients, vi is a pre-trained and set latent vector of Xi, vj is a pre-trained and set latent vector of Xj, and < > denotes a dot product operation.

Meanwhile, referring to Equation 3, the first popularity potential index may correspond to the inter-artist similarity reflecting the interaction between a plurality of first merged attribute variables.

Next, in step S21222, the service server 20 may input the first and second artist attribute data, city attribute data, and popularity index data of the popular artist into a pre-trained second algorithm model to calculate a 2-2 popularity index of the promising artist.

Here, the 2-2 popularity index may be an index that further reflects the artist popularity trend in the first city.

According to an embodiment, the service server 20 may generate a plurality of second merged attribute variables obtained by merging the above-described plurality of first and second attribute variables, one or more third attribute variables included in the city attribute data, and a fourth attribute variable corresponding to the first popularity index of the popular artist with respect to the first city, and may input the generated plurality of second merged attribute variables into the second algorithm model to calculate the 2-2 popularity index.

Specifically, the plurality of first and second attribute variables have been described above. In addition, the third attribute variable may be one or more city variables included in the city attribute data. The plurality of second merged attribute variables may be generated by merging the plurality of first and second attribute variables, one or more third attribute variables, and the fourth attribute variable according to preset conditions. For example, when the first attribute variable is “(x_popular1, x_popular2, . . . , x_popularm)”, the second attribute variable is “(x_promising1, x_promising2, . . . , x_promisingm)”, the third attribute variable is “(x_city1, x_city2, . . . , x_cityp)”, and the fourth attribute variable is “(x_popularityindex)”, the plurality of second merged attribute variables may be expressed as “(x_popular1, x_popular2, . . . , x_popularm, x_promising1, x_promising2, . . . , x_promisingm, x_city1, x_city2, . . . , x_cityp, x_popularityindex)”.

In addition, the second algorithm model may be an artificial neural network-based algorithm model. In this case, the artificial neural network-based algorithm model may have the structure of Multi-Layer Neural Networks and may be a DNN (Deep Neural Network) model including an input layer, two or more hidden layers, and an output layer. The input layer is a layer that accepts external data, and the number of neurons in the input layer is equal to the number of input variables. The hidden layers are located between the input layer and the output layer, and receive signals from the input layer to extract features and transmit them to the output layer. The output layer receives signals from the hidden layers and outputs output values based on the received signals. Input signals between neurons are multiplied by their respective weights (connection strengths) and then summed, and if this sum exceeds the neuron's threshold, the neuron is activated and outputs the output value obtained through the activation function.

Referring to the above description, the input layer may receive a plurality of second merged attribute variables as input, two or more hidden layers may generate a latent vector reflecting the nonlinear interactions of the plurality of second merged attribute variables, and the output layer may output the second popularity potential index based on the latent vector. In this case, each of the two or more hidden layers may calculate an output value as shown in Equation 4 below.

$${H}^{( L )} = f ( {W}^{( L )} {H}^{( L - 1 )} + {b}^{( L )} ) \qquad [ Equation 4 ]$$

Here, H(L) is the output value of the L-th hidden layer, W(L) is the weight matrix of the L-th hidden layer, H(L−1) is the output value of the (L−1)-th hidden layer, b(L) is the bias vector of the L-th hidden layer, and f( ) is an activation function with nonlinearity.

Meanwhile, referring to Equation 4, the second popularity potential index may correspond to the similarity reflecting the trend of the first city according to the nonlinear interactions between the plurality of second merged attribute variables.

Finally, in step S21223, the service server 20 may calculate the second popularity index of the promising artist by combining the 2-1 and 2-2 popularity indexes.

According to an embodiment, the service server 20 may calculate the second popularity index of the promising artist by summing the 2-1 and 2-2 popularity indexes. According to another embodiment, the service server 20 may calculate the second popularity index of the promising artist by summing the 2-1 and 2-2 popularity indexes and then performing a sigmoid transformation.

In summary, the service server 20 may predict the 2-1 popularity index corresponding to the profile and facial similarity between the popular artist and the promising artist, and then adjust or correct the 2-1 popularity index with the 2-2 popularity index reflecting the artist popularity trend of the first city to calculate the second popularity index corresponding to the probability that the promising artist will succeed in the first city.

Meanwhile, in FIG. 13 and the like, the content of calculating the growth potential index of the promising artist based on one popular artist in the first city has been described. However, there may be a plurality of popular artists in the first city. In this case, the service server 20 may calculate a plurality of second popularity indexes for the promising artist by performing the steps of FIG. 6 for each of the plurality of popular artists, and may calculate the maximum value among the plurality of second popularity indexes as the second popularity index of the promising artist.

Referring back to FIG. 11, in step S213, the service server 20 may calculate the growth potential index of the promising artist based on the first and second popularity indexes of the promising artist.

In this case, as described above, the growth potential index of the promising artist may be defined as a measure indicating how much more popular the promising artist will grow in the first city in the future.

According to an embodiment, the growth potential index of the promising artist may be a relationship value between the second popularity index of the promising artist and the first popularity index of the promising artist.

As one example, the relationship value may correspond to the difference value between the second popularity index of the promising artist and the first popularity index of the promising artist. As another example, the relationship value may correspond to the ratio value of the second popularity index of the promising artist to the first popularity index of the promising artist.

That is, the first popularity index of the promising artist may correspond to the actual popularity of the promising artist in the first city, and the second popularity index of the promising artist may correspond to the predicted popularity indicating how popular the promising artist can become compared to the popular artist. Accordingly, by calculating the relationship value (e.g., difference value) between the predicted popularity (i.e., second popularity index) and the actual popularity (i.e., first popularity index) of the promising artist, the growth potential index—a measure indicating how much more popular the promising artist will grow in the first city in the future—can be efficiently derived.

Referring back to FIG. 10, in step S220, the service server 20 may recommend one or more cities from among the plurality of cities based on the growth potential index for each of the plurality of cities for the promising artist.

According to an embodiment, the service server 20 may select and recommend the top N (integer of 1 or more) cities with the highest growth potential index from among the plurality of cities. According to another embodiment, the service server 20 may select and recommend N cities whose growth potential index is higher than a preset threshold value from among the plurality of cities. In addition, various recommendation methods in various embodiments may be used in addition to the above-described recommendation methods.

In summary, the recommendation method according to an embodiment of the present invention can efficiently calculate the growth potential index of a promising artist—a measure indicating how much more popular the promising artist will grow in the target city in the future—by comparing the actual popularity (i.e., first popularity index) and the predicted popularity (i.e., second popularity index) of the promising artist in the target city.

In addition, by utilizing the growth potential index of the promising artist calculated for each of the plurality of cities, one or more cities suitable for the promising artist to conduct or promote promotional activities can be efficiently recommended from among the plurality of cities. That is, if a promising artist who has not yet entered the target city has a high growth potential index, the person in charge can actively conduct promotions in the target city. In addition, if a promising artist who has already entered the target city has a low actual popularity but a high growth potential index, the person in charge can further promote the promotions.

Hereinafter, a method for calculating a popularity potential index of a target city for a promising artist, which is performed by the processor 23 of the service server 20, will be described in detail with reference to FIG. 17 and the like.

FIG. 17 is a diagram showing an overall flowchart of a method for calculating a popularity potential index according to an embodiment of the present invention.

Here, FIG. 17 shows the steps for calculating the popularity potential index of a promising artist in a target city, which is one of a plurality of cities. These steps of FIG. 17 may be equally applied to cities other than the target city.

As described above, a promising artist refers to an artist who is not yet widely known in the target city, and a popular artist refers to an artist who is already famous in the target city.

In addition, the popular artist may be selected based on the popularity index for each of a plurality of artists in the target city, which is calculated in advance and stored in the storage unit 24. Here, the popularity index may correspond to a score indicating how popular the artist is in the target city, and may be calculated in advance in the service server 20. For example, the popular artist may be an artist having a ratio of the popularity index in the upper rank among a plurality of artists.

The steps of FIG. 17 will be described in detail below.

In step S310, the service server 20 may generate input data including data related to the popular artist, data related to the promising artist, and data related to the target city.

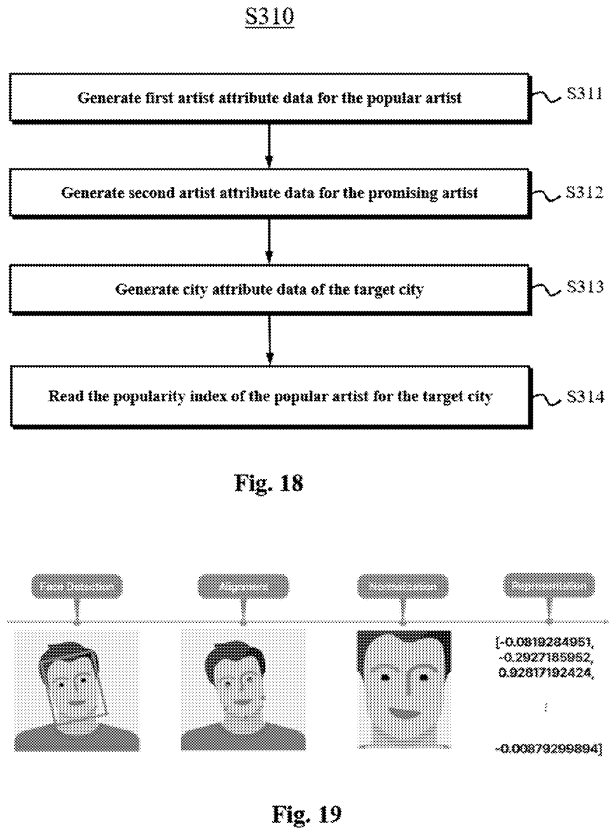

FIG. 18 is a diagram showing a detailed flowchart of step S310 among the steps of FIG. 17.

First, in step S311, the service server 20 may generate first artist attribute data for the popular artist. Here, the first artist attribute data may include profile data and facial data.

According to an embodiment, the profile data of the popular artist may include one or more profile variables corresponding to at least one of the age, gender, height, nationality, languages spoken, personality type, position within the group artist, solo activity information, and characteristic information evaluated by fans of the popular artist.

Here, age may be defined as a concept including date of birth, personality type may correspond to MBTI (Myers-Briggs Type Indicator), and position within the group artist may correspond to the role the popular artist plays within the group artist. In addition, solo activity information is information about whether the artist performs individual activities separately from group activities of the group artist, and may include whether the artist performs solo activities and the number of solo albums. The characteristic information evaluated by fans is information evaluated by fans of the popular artist about the popular artist, and may include concept evaluation (e.g., innocence, elegance, coldness), personality evaluation (e.g., playfulness, entertainment sense), etc.

Meanwhile, in step S311, the service server 20 may perform a preprocessing process on raw profile data of the popular artist obtained from the information providing server 30 to generate profile data of the popular artist.

Here, the raw profile data may include one or more numerical raw profile variables and one or more categorical raw profile variables. In this case, the service server 20 may perform a preprocessing process on numerical raw profile variables by standardizing or normalizing them. In addition, the service server 20 may perform a preprocessing process on categorical raw profile variables by converting them into numerical variables. In this case, one-hot encoding may be used in the preprocessing process for categorical raw profile variables.

For example, the service server 20 may convert MBTI, which is a categorical raw profile variable, into profile variables which are numerical variables using one-hot encoding as shown in Table 1 below.

TABLE 1

| MBTI | I/E | N/S | T/F | J/P |
|---|---|---|---|---|
| ISTJ | 1 | 0 | 1 | 1 |
| ISFJ | 1 | 0 | 0 | 1 |
| INFJ | 1 | 1 | 0 | 1 |
| INTJ | 1 | 1 | 1 | 1 |
| ISTP | 1 | 0 | 1 | 0 |
| ISFP | 1 | 0 | 0 | 0 |
| INFP | 1 | 1 | 0 | 0 |
| INTP | 1 | 1 | 1 | 0 |
| ESTP | 0 | 0 | 1 | 0 |
| ESFP | 0 | 0 | 0 | 0 |
| ENFP | 0 | 1 | 0 | 0 |
| ENTP | 0 | 1 | 1 | 0 |
| ESTJ | 0 | 0 | 1 | 1 |
| ESFJ | 0 | 0 | 0 | 1 |
| ENFJ | 0 | 1 | 0 | 1 |
| ENTJ | 0 | 1 | 1 | 1 |

In addition, according to an embodiment, the facial data of the popular artist may include a plurality of facial variables related to facial features of the popular artist. Here, the plurality of facial variables may correspond to a plurality of vector elements included in a facial feature vector (i.e., facial embedding vector).

Meanwhile, in step S311, the service server 20 may extract a facial region from an image of the popular artist (Face Detection process), may extract a plurality of landmarks from the facial region (Alignment process), may rotate the facial region based on the plurality of landmarks (Normalization process), and then may calculate a plurality of facial variables corresponding to a multi-dimensional facial feature vector (Representation process). In this case, when a plurality of images of the popular artist are used, the a-th facial variable among the plurality of facial variables may correspond to the average value of the a-th element of the facial embedding vector for each image.

FIG. 19 illustrates the concept of calculating facial data from a single image according to an embodiment of the present invention. Referring to FIG. 19, the service server 20 may input a single image into an MTCNN (Multi-task Cascaded Convolutional Networks) model to perform the Face Detection process, Alignment process, and Normalization process, and may input the output value of MTCNN into a combined model of the ArcFace model to perform the Representation process.

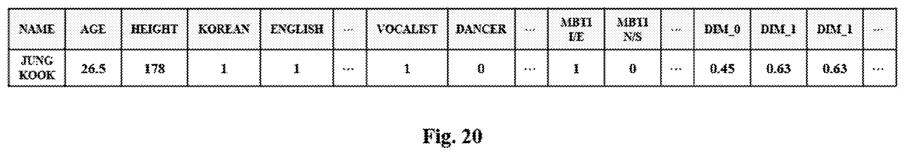

First artist attribute data of the popular artist may be generated according to the above-described content. FIG. 20 shows an example of the first artist attribute data of the popular artist.

Next, in step S312, the service server 20 may generate second artist attribute data for the promising artist. Here, the second artist attribute data may also include profile data and facial data.

Since the process of step S312 is almost the same as that of step S311, duplicate description will be omitted.

Continuing, in step S313, the service server 20 may generate city attribute data of the target city. Here, the city attribute data may be used to analyze the artist popularity trend of the target city.

According to an embodiment, the city attribute data may include one or more city variables corresponding to at least one of the country and continent to which the target city belongs, whether the target city is a capital, population, ethnic information, religious information, and economic indicator information.

Here, ethnic information may correspond to the population or proportion by ethnicity of citizens residing in the target city, religious information may correspond to the number or proportion of believers by religion of citizens residing in the target city, and economic indicator information may correspond to income/distribution indicators such as GDP and GINI index.

Meanwhile, in step S313, the service server 20 may perform a preprocessing process on raw city attribute data of the target city obtained from the information providing server 30 to generate city attribute data of the target city.

In this case, similarly to the above, the raw city attribute data may include one or more numerical raw city variables and one or more categorical raw city variables, and a preprocessing process for categorical raw city variables may be performed by converting the categorical raw city variables into numerical variables.

Finally, in step S314, the service server 20 may read the popularity index of the popular artist for the target city from the storage unit 24.

As described above, the popularity index for each artist may be calculated in advance and stored in the storage unit 24, and the service server 20 may read the popularity index of the popular artist from among the popularity index for each artist.

Referring back to FIG. 17, in step S320, the service server 20 may calculate the popularity potential index of the target city for the promising artist based on the input data.

As described above, the popularity potential index may correspond to a predicted popularity index indicating how popular the promising artist in the target city will be at a future point in time. In this case, by using the above-described input data, the popularity potential index can reflect how similar the attributes of the promising artist are to the attributes of the popular artist and the artist popularity trend of the target city.

Step S320 will now be described in detail with reference to FIG. 20.

FIG. 20 is a diagram showing a detailed flowchart of step S320 among the steps of FIG. 17.

First, in step S321, the service server 20 may input the first and second artist attribute data into a pre-trained first algorithm model to calculate a first popularity potential index.

Here, the first popularity potential index may be an index reflecting the similarity between the popular artist and the promising artist.

According to an embodiment, the service server 20 may generate a plurality of first merged attribute variables obtained by merging a plurality of first attribute variables included in the first artist attribute data and a plurality of second attribute variables included in the second artist attribute data, and may input the generated plurality of first merged attribute variables into the first algorithm model to calculate the first popularity potential index.

Specifically, the plurality of first attribute variables may be one or more profile variables of the popular artist included in the first artist attribute data and a plurality of facial variables of the popular artist. In addition, the plurality of second attribute variables may be one or more profile variables of the promising artist included in the second artist attribute data and a plurality of facial variables of the promising artist. The plurality of first merged attribute variables may be generated by merging the plurality of first attribute variables and the plurality of second attribute variables according to preset conditions. For example, when the plurality of first attribute variables are “(x_popular1, x_popular2, . . . , x_popularm)” and the plurality of second attribute variables are “(x_promising1, x_promising2, . . . , x_promisingm)”, the plurality of first merged attribute variables may be expressed as “(x_popular1, x_popular2, . . . , x_popularm, x_promising1, x_promising2, . . . , x_promisingm)”.

More specifically, the service server 20 may apply the plurality of first merged attribute variables to Equation 5 below corresponding to the first algorithm model to calculate the first popularity potential index.

$$y = {w}_{0} + {\sum }_{i = 1}^{n} {w}_{i} {X}_{i} , + {{\sum }_{i = 1}}^{n} {{\sum }_{j = i + 1}}^{n} 〈 {v}_{i} , {v}_{j} 〉 {X}_{i} {X}_{j} \qquad [ Equation 5 ]$$

Here, y is the first popularity potential index, i and j are indexes of the first merged attribute variables, n is the number of first merged attribute variables, Xi and Xj are first merged attribute variables, w0 and wi are pre-trained and set coefficients, vi is a pre-trained and set latent vector of Xi, vj is a pre-trained and set latent vector of Xj, and < > denotes a dot product operation.

Meanwhile, referring to Equation 5, the first popularity potential index may correspond to the inter-artist similarity reflecting the interaction between a plurality of first merged attribute variables.

Next, in step S322, the service server 20 may input the first and second artist attribute data, city attribute data, and popularity index data of the popular artist into a pre-trained second algorithm model to calculate a second popularity potential index.

Here, the second popularity potential index may be an index that further reflects the artist popularity trend in the target city.

According to an embodiment, the service server 20 may generate a plurality of second merged attribute variables obtained by merging the above-described plurality of first and second attribute variables, one or more third attribute variables included in the city attribute data, and a fourth attribute variable corresponding to the popularity index data of the popular artist with respect to the target city, and may input the generated plurality of second merged attribute variables into the second algorithm model to calculate the second popularity potential index.

Specifically, the plurality of first and second attribute variables have been described above. In addition, the third attribute variable may be one or more city variables included in the city attribute data. The plurality of second merged attribute variables may be generated by merging the plurality of first and second attribute variables, one or more third attribute variables, and the fourth attribute variable according to preset conditions. For example, when the first attribute variable is “(x_popular1, x_popular2, . . . , x_popularm)”, the second attribute variable is “(x_promising1, x_promising2, . . . , x_promisingm)”, the third attribute variable is “(x_city1, x_city2, . . . , x_cityp)”, and the fourth attribute variable is “(x_popularityindex)”, the plurality of second merged attribute variables may be expressed as “(x_popular1, x_popular2, . . . , x_popularm, x_promising1, x_promising2, . . . , x_promisingm, x_city1, x_city2, . . . , x_cityp, x_popularityindex)”.

In addition, the second algorithm model may be an artificial neural network-based algorithm model. In this case, the artificial neural network-based algorithm model may have the structure of Multi-Layer Neural Networks and may be a DNN (Deep Neural Network) model including an input layer, two or more hidden layers, and an output layer. The input layer is a layer that accepts external data, and the number of neurons in the input layer is equal to the number of input variables. The hidden layers are located between the input layer and the output layer, and receive signals from the input layer to extract features and transmit them to the output layer. The output layer receives signals from the hidden layers and outputs output values based on the received signals. Input signals between neurons are multiplied by their respective weights (connection strengths) and then summed, and if this sum exceeds the neuron's threshold, the neuron is activated and outputs the output value obtained through the activation function.

Referring to the above description, the input layer may receive a plurality of second merged attribute variables as input, two or more hidden layers may generate a latent vector reflecting the nonlinear interactions of the plurality of second merged attribute variables, and the output layer may output the second popularity potential index based on the latent vector. In this case, each of the two or more hidden layers may calculate an output value as shown in Equation 6 below.

$${H}^{( L )} = f ( {W}^{( L )} {H}^{( L - 1 )} + {b}^{( L )} ) \qquad [ Equation 6 ]$$

Here, H(L) is the output value of the L-th hidden layer, W(L) is the weight matrix of the L-th hidden layer, H(L−1) is the output value of the (L−1)-th hidden layer, b(L) is the bias vector of the L-th hidden layer, and f( ) is an activation function with nonlinearity.

Meanwhile, referring to Equation 6, the second popularity potential index may correspond to the similarity reflecting the trend of the target city according to the nonlinear interactions between the plurality of second merged attribute variables.

Finally, in step S323, the service server 20 may calculate the popularity potential index of the promising artist by combining the first and second popularity potential indexes.

According to an embodiment, the service server 20 may calculate the popularity potential index of the promising artist by summing the first and second popularity potential indexes. According to another embodiment, the service server 20 may calculate the popularity potential index of the promising artist by summing the first and second popularity potential indexes and then performing a sigmoid transformation.

In summary, the service server 20 according to an embodiment of the present invention may predict the first popularity potential index, which is an index corresponding to the profile and facial similarity between the popular artist and the promising artist, and then adjust or correct the first popularity potential index with the second popularity potential index, which is an index reflecting the artist popularity trend of the target city, to calculate the popularity potential index corresponding to the probability that the promising artist will succeed in the specific city. Based on this popularity potential index of the promising artist, whether to enter the target city for the promising artist can be determined systematically and accurately.

Meanwhile, the method for calculating the popularity index of the above-described popular artist will be briefly described below based on FIG. 8.

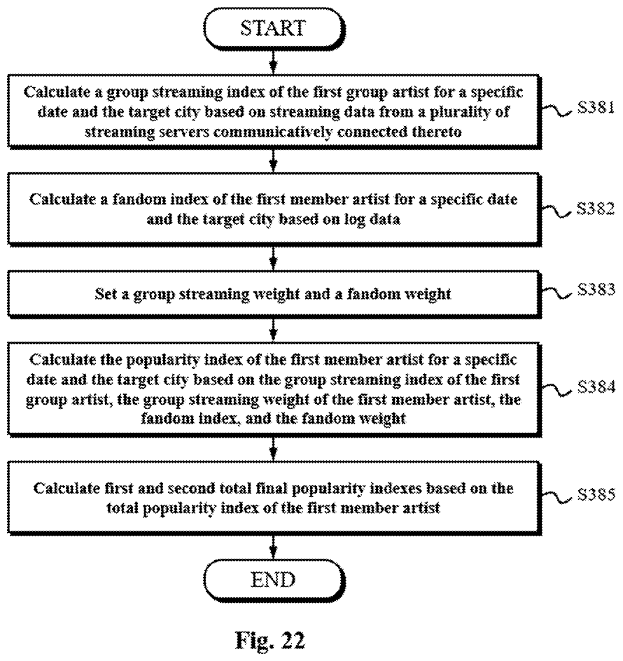

FIG. 22 is a diagram showing an overall flowchart of a method for calculating the popularity index of an artist in a target city according to an embodiment of the present invention.

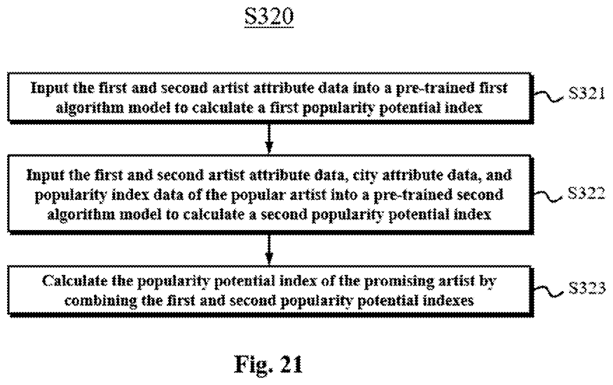

Here, the member artist described in FIG. 22 is included in a group artist, and is the same concept as the “artist” described in FIGS. 1 to 21. In this case, the group artist may be composed of one or two or more member artists. Therefore, the popular artist is the same as the first member artist to be described in FIG. 8. For convenience of description, hereinafter, the popular artist is referred to as the first member artist.

In addition, the popularity index may be a total popularity index, which is the popularity index of the first member artist up to a specific date. Here, the total popularity index may correspond to the cumulative popularity index, long-term popularity index, career popularity index, overall popularity index, etc. of the first member artist. However, the present invention is not limited thereto, and the popularity index may be a current popularity index, which is the popularity index of the first member artist on a specific date itself. Here, the current popularity index may correspond to the short-term popularity index, recent popularity index, etc. of the first member artist. Hereinafter, the popularity index is assumed to be the total popularity index in describing this embodiment.

In addition, the service server 20 may be communicatively connected to each of a plurality of terminal devices (not shown) and may provide a fandom service to a plurality of users corresponding to fans. That is, the service server 20 may be a service server that provides a fandom service.

The steps of FIG. 22 will be described in detail below.

In step S381, the service server 20 may calculate a group streaming index of the first group artist for a specific date and the target city based on streaming data from a plurality of streaming servers communicatively connected thereto. Here, the streaming server may correspond to the information providing server 30.

Here, the streaming data may be data related to statistics of the streaming history of the streaming server for the first group artist, and the group streaming index may be a streaming index for the first group artist.

Specifically, the service server 20 may calculate at least one streaming indicator among a group music streaming indicator and a group video streaming indicator of the first group artist, and may calculate the group streaming index based on the at least one streaming indicator.

Here, the group music streaming indicator may be related to music tracks and/or music albums of the first group artist with respect to a specific date and the target city, and may be calculated based on streaming data from two or more first streaming servers among the plurality of streaming servers that provide music streaming services. In addition, the group video streaming indicator may be related to videos of the first group artist with respect to a specific date and the target city, and may be calculated based on streaming data from one or more second streaming servers among the plurality of streaming servers that provide video streaming services. When both the group music streaming indicator and the group video streaming indicator are used, the service server 20 may calculate the total sum or weighted sum of the group music streaming indicator and the group video streaming indicator as the group streaming index.

More specifically, the service server 20 may calculate the group music streaming indicator based on at least one of the first, second, and third group music streaming indicators.

Here, the first group music streaming indicator may be related to the number of listeners who have listened to music tracks of the first group artist in the target city up to a specific date. As an example, the service server 20 may calculate the first group music streaming indicator based on the sum of the number of listeners in the target city on a monthly basis up to a specific date.

In addition, the second group music streaming indicator may be related to the number of music tracks of the first group artist listed on the music chart of the target city up to a specific date, and the third group music streaming indicator may be related to the number of music albums of the first group artist listed on the music chart of the target city up to a specific date.

In addition, the service server 20 may calculate the group video streaming indicator based on the number of views for videos of the first group artist up to a specific date. Here, the videos of the first group artist may be videos produced by a video creator based in the target city based on the music tracks of the first group artist. That is, the video creator may be a creator residing in the target city. The number of views may be aggregated for viewers worldwide.

In step S382, the service server 20 may calculate a fandom index of the first member artist for a specific date and the target city based on log data.

Specifically, the above-described fandom service may be configured to include fan participation services such as popularity voting for artists and writing comments in artist communities, content provision services that provide various content such as music, videos, and interviews of artists, merchandise sales services that sell fan goods, albums, and concert tickets for artists, and event provision services that provide events such as fan meetings. Fan activities using such a fandom service may correspond to online fandom activities for a specific artist, and data related to the fandom service may be stored as log data in the service server 20. In this case, the service server 20 may calculate a fandom index of the first member artist for a specific date and the target city based on the log data.

More specifically, the service server 20 may calculate the fandom index based on at least one of first and second fandom indicators. The first fandom indicator may be related to popularity voting for the first member artist in the target city conducted on the service server 20. Here, the popularity vote may be a free popularity vote and may include a preliminary popularity vote and a main popularity vote. The value of the popularity vote may be the cumulative value of the popularity votes for the first member artist up to a specific date. In addition, the second fandom indicator may be related to information about payments made by fans based in the target city for goods related to the first member artist. Here, goods may include fan goods, concert tickets, participation in paid popularity voting, etc. of the first member artist. For example, payment information may be information about payment for goods using digital assets sold for a fee on the service server 20. As another example, payment information may be information about direct payment for goods using a credit card or the like through the service server 20.

In step S383, the service server 20 may set a group streaming weight and a fandom weight. Here, the group streaming weight is a weight related to the group streaming index and may have any value between 0 and 1. The group streaming weight may be set based on whether the first group artist performs group activities within a predetermined specific period and the number of member artists included in the first group artist. In addition, the fandom weight is a weight related to the fandom index and may have any value between 0 and 1, and may be set to a specific fixed value (for example, a third value).

According to the first embodiment, when the first group artist is composed of two or more member artists including the first member artist and the first group artist performs group activities within a specific period, the service server 20 may set the group streaming weight to have a first value corresponding to the contribution of the first member artist to the first group artist.

Specifically, in step S382, the service server 20 may further calculate the fandom index of other member artists of the first group artist for a specific date and the target city based on the log data. The fandom index of the other member artists may be calculated similarly to the fandom index of the first member artist described above. In this case, in step S383, the service server 20 may calculate the first value based on the fandom index for each member artist belonging to the first group artist. According to an embodiment, the service server 20 may set the ratio of the fandom index of the first member artist to the sum or weighted sum of the fandom index for each member artist belonging to the first group artist as the first value.

According to the second embodiment, when the first group artist is a solo artist including only the first member artist, the service server 20 may set the group streaming weight to have a preset second value. In this case, the second value may have a fixed value.

According to the third embodiment, when the first group artist is composed of two or more member artists including the first member artist but the first group artist does not perform group activities during a specific period, the service server 20 may set the group streaming weight to have the second value. That is, since the above-described first member artist is essentially a solo artist, the same group streaming weight as that of a solo artist may be assigned.

In step S384, the service server 20 may calculate the popularity index of the first member artist for a specific date and the target city based on the group streaming index of the first group artist, the group streaming weight of the first member artist, the fandom index, and the fandom weight.

According to an embodiment, the service server 20 may calculate the popularity index of the first member artist based on a computed value A obtained by multiplying the group streaming weight of the first member artist and the group streaming index of the first group artist, and a computed value B obtained by multiplying the fandom weight and the fandom index of the first member artist.

Meanwhile, there may be cases in which the first group artist is composed of two or more member artists including the first member artist, and the first group artist performs group activities while the first member artist also performs individual activities within a specific period. In this case, the streaming index related to the individual activities of the first member artist must be included in the popularity index of the first member artist. Therefore, the service server 20 may further calculate the member streaming index of the first member artist who performs individual activities, further set a member streaming weight related to the member streaming index, and calculate the popularity index of the first member artist further based on the member streaming index and the member streaming weight.

Specifically, in step S381, the service server 20 may further calculate the member streaming index of the first member artist for a specific date and the target city based on streaming data from the plurality of streaming servers. Here, the member streaming index may be calculated similarly to the group streaming index described above.

Thereafter, in step S383, the service server 20 may further set the member streaming weight. In this case, the member streaming weight has any value between 0 and 1, and may be set in particular to the second value. Meanwhile, the group streaming weight may be set to the first value corresponding to the above-described contribution.

Finally, in step S384, the service server 20 may calculate the popularity index of the first member artist further based on the member streaming index and the member streaming weight.

According to an embodiment, the service server 20 may calculate a first computed value based on the first average value of the group streaming weight and the member streaming weight and the second average value of the group streaming index and the member streaming index, may calculate a third computed value based on the fandom weight and the fandom index, and may calculate the popularity index based on the first and third computed values.

According to another embodiment, the service server 20 may calculate a second computed value based on the first multiplication computed value of the group streaming weight and the group streaming index and the second multiplication computed value of the member streaming weight and the member streaming index, may calculate a third computed value based on the fandom weight and the fandom index, and may calculate the popularity index based on the second and third computed values.

The popularity index for the popular artist can be calculated in advance through the above-described process.

In step S385, the service server 20 may calculate first and second total final popularity indexes based on the total popularity index of the first member artist.

According to an embodiment, the first total final popularity index may be defined as an intra-city popularity index obtained by sorting the popularity indexes of a plurality of member artists in a specific city.

According to an embodiment, the second total final popularity index may be defined as an inter-city popularity index obtained by sorting the popularity indexes of a specific member artist across a plurality of cities.

In addition, embodiments of the present invention may be implemented in the form of program instructions that can be executed through various computer means and recorded on a computer-readable medium. The computer-readable medium may include program instructions, data files, data structures, etc., alone or in combination. Program instructions recorded on the medium may be specially designed and configured for the present invention, or may be known and available to those skilled in computer software. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program instructions such as ROM, RAM, and flash memory. Examples of program instructions include not only machine language code such as that produced by a compiler, but also high-level language code that can be executed by a computer using an interpreter or the like. The hardware devices described above may be configured to operate as one or more software modules to perform the operations of the embodiments of the present invention, and vice versa.

As described above, the present invention has been described by specific matters such as specific components and limited embodiments and drawings, but this is provided only to help the overall understanding of the present invention. The present invention is not limited to the above embodiments, and various modifications and variations are possible from this description by those of ordinary skill in the art to which the present invention belongs. Therefore, the spirit of the present invention should not be limited to the described embodiments, and not only the claims set forth below, but also all things with equivalents or equivalent modifications to the claims fall within the scope of the spirit of the present invention.

What is claimed is:

1. A method for recommending a promising artist in a target city performed in a processor-based device, the method comprising:
step (a) of calculating a growth potential index for each of a plurality of promising artists with respect to the target city; and
step (b) of recommending one or more promising artists from among the plurality of promising artists based on the growth potential index for each of the plurality of promising artists,
wherein the growth potential index for each of the plurality of promising artists is calculated based on the actual popularity of each of the plurality of promising artists in the target city and the similarity between each of the plurality of promising artists and a popular artist in the target city.

2. The method of claim 1, wherein step (b) selects and recommends the top N (integer of 1 or more) promising artists with the highest growth potential index from among the plurality of promising artists.

3. The method of claim 1, wherein step (b) selects and recommends N (integer of 1 or more) promising artists whose growth potential index is higher than a preset threshold value from among the plurality of promising artists.

4. The method of claim 1, wherein step (a) for a first promising artist among the plurality of promising artists comprises:
step (a1) of calculating a first popularity index of the first promising artist corresponding to the actual popularity of the first promising artist in the target city;
step (a2) of calculating a second popularity index of the first promising artist corresponding to the similarity between the popular artist in the target city and the first promising artist; and
step (a3) of calculating a growth potential index of the first promising artist based on a relationship value between the second popularity index of the first promising artist and the first popularity index of the first promising artist.

5. The method of claim 4, wherein the relationship value corresponds to the difference value between the second popularity index of the first promising artist and the first popularity index of the first promising artist.

6. The method of claim 4, wherein when there are a plurality of popular artists in the target city, the second popularity index of the first promising artist corresponds to the maximum value among the second popularity indexes of the first promising artist with respect to each of the plurality of popular artists.

7. The method of claim 4, wherein step (a1) calculates a group streaming index of a first group artist with respect to the target city based on streaming data from a plurality of streaming servers, and calculates the first popularity index of the first promising artist based on the group streaming index and a predefined group streaming weight,
wherein the first group artist is composed of one or more member artists, and the one or more member artists include a first member artist who is the first promising artist.

8. The method of claim 7, wherein step (a1) calculates at least one streaming indicator among a group music streaming indicator and a group video streaming indicator of the first group artist, and calculates the group streaming index based on the at least one streaming indicator,
wherein the group music streaming indicator is related to music tracks and/or music albums of the first group artist with respect to the target city, and is calculated based on streaming data from two or more first streaming servers among the plurality of streaming servers that provide music streaming services, and
wherein the group video streaming indicator is related to videos of the first group artist with respect to the target city, and is calculated based on streaming data from one or more second streaming servers among the plurality of streaming servers that provide video streaming services.

9. The method of claim 7, wherein the group streaming weight has a first value corresponding to the contribution of the first promising artist to the first group artist when the first group artist is composed of two or more member artists including the first promising artist and the first group artist performs group activities within a predetermined specific period, and
has a preset second value when the first group artist is a solo artist including only the first promising artist, or when the first group artist is composed of two or more member artists including the first promising artist but the first group artist does not perform group activities during a predetermined specific period.

10. The method of claim 7, wherein step (a1) further calculates a fandom index of the first promising artist based on predefined online fandom activity data, and calculates the first popularity index of the first promising artist further based on the fandom index of the first promising artist and a preset fandom weight.

11. The method of claim 4, wherein step (a2) comprises:
step (a21) of generating input data comprising first artist attribute data of the popular artist, second artist attribute data of the first promising artist, city attribute data of the target city, and a pre-calculated first popularity index of the popular artist; and
step (a22) of calculating the second popularity index of the first promising artist based on the input data.

12. The method of claim 11, wherein each of the first and second artist attribute data includes at least one of profile data and facial data,
wherein the profile data includes one or more profile variables corresponding to at least one of the age, gender, height, nationality, languages spoken, personality type, position within the group artist, solo activity information, and characteristic information evaluated by fans of the corresponding artist, and
wherein the facial data is calculated based on artist images of the corresponding artist and includes a plurality of facial variables.

13. The method of claim 11, wherein the city attribute data includes one or more city variables corresponding to at least one of the country and continent to which the target city belongs, whether the target city is a capital, population, ethnic information, religious information, and economic indicator information.

14. The method of claim 11, wherein step (a22) comprises:
step (a221) of inputting the first and second artist attribute data into a pre-trained first algorithm model to calculate a 2-1 popularity index corresponding to the similarity between the popular artist and the first promising artist;
step (a222) of inputting the first and second artist attribute data, the city attribute data, and the first popularity index of the popular artist into a pre-trained second algorithm model to calculate a 2-2 popularity index corresponding to the artist popularity trend in the target city; and
step (a223) of combining the 2-1 and 2-2 popularity indexes to calculate the second popularity index of the promising artist.

15. The method of claim 11, wherein step (a221) calculates the 2-1 popularity index by applying a plurality of first merged attribute variables, obtained by merging a plurality of first attribute variables included in the first artist attribute data and a plurality of second attribute variables included in the second artist attribute data, to the equation below corresponding to the first algorithm model,
$$y = {w}_{0} + {\sum }_{i = 1}^{n} {w}_{i} {X}_{i} , + {{\sum }_{i = 1}}^{n} {{\sum }_{j = i + 1}}^{n} 〈 {v}_{i} , {v}_{j} 〉 {X}_{i} {X}_{j}$$
wherein y is the 2-1 popularity index, i and j are indexes of the first merged attribute variables, n is the number of first merged attribute variables, Xi and Xj are the first merged attribute variables, w0 and wi are pre-trained and set coefficients, vi is a pre-trained and set latent vector of Xi, vj is a pre-trained and set latent vector of Xj, and < > denotes a dot product operation.

16. The method of claim 11, wherein step (a222) inputs a plurality of second merged attribute variables, obtained by merging a plurality of first attribute variables included in the first artist attribute data, a plurality of second attribute variables included in the second artist attribute data, one or more third attribute variables included in the city attribute data, and a fourth attribute variable corresponding to the first popularity index of the popular artist, into the second algorithm model to calculate the 2-2 popularity index reflecting nonlinear interactions between the second merged attribute variables,
wherein the second algorithm model is an artificial neural network algorithm model including an input layer, two or more hidden layers, and an output layer, and the activation function defining the hidden layers has nonlinearity.

17. A method for calculating a growth potential index of a promising artist in a target city performed in a processor-based device, the method comprising:
a step of calculating a first popularity index of the promising artist corresponding to the actual popularity of the promising artist with respect to the target city;
a step of calculating a second popularity index of the promising artist corresponding to the similarity between a popular artist in the target city and the promising artist; and
a step of calculating a growth potential index of the promising artist based on the first and second popularity indexes of the promising artist.

18. A non-transitory computer-readable recording medium having a program recorded thereon for executing the method according to claim 1.

19. A server comprising:
a memory storing computer-readable instructions; and
a processor implemented to execute the instructions,
wherein the processor calculates a growth potential index for each of a plurality of promising artists with respect to the target city and recommends one or more promising artists from among the plurality of promising artists based on the growth potential index for each of the plurality of promising artists,
wherein the growth potential index for each of the plurality of promising artists is calculated based on the actual popularity of each of the plurality of promising artists in the target city and the similarity between each of the plurality of promising artists and a popular artist in the target city.

20. A server comprising:
a memory storing computer-readable instructions; and
a processor implemented to execute the instructions,
wherein the processor calculates a first popularity index of the promising artist corresponding to the actual popularity of the promising artist with respect to the target city,
calculates a second popularity index of the promising artist corresponding to the similarity between a popular artist in the target city and the promising artist, and
calculates a growth potential index of the first promising artist based on the first and second popularity indexes of the promising artist.
